(19) United States
(12) Patent Application Publication
(10) Pub. No.: US 2026/0349360 A1
(43) Pub. Date: Nov. 5, 2026

(54) IMAGE FORMING APPARATUS

(71) Applicant: CANON KABUSHIKI KAISHA, Tokyo (JP)

(72) Inventors: HARUHIKO MITSUDA, Chiba (JP); TAKANORI UENO, Kanagawa (JP); KENICHI IKARI, Chiba (JP)

(21) Appl. No.: 19/634,785

(22) Filed: Mar. 31, 2026

(30) Foreign Application Priority Data
Apr. 15, 2025 (JP) 2025-067022

(51) Int. Cl. G03G 5/06; G03G 5/05; G03G 15/04

(52) U.S. Cl. CPC G03G 5/0612; G03G 5/056; G03G 5/0696; G03G 15/04054; G03G 2215/0409

(57) ABSTRACT

Provided is an image forming apparatus including: a photosensitive drum; and light emitting elements for emitting exposure light to be applied to the surface of the photosensitive drum, wherein the light emitting elements are each an organic EL element, wherein the photosensitive drum includes a support, a charge generating layer, and a charge transporting layer, wherein the charge transporting layer contains at least one compound selected from the group consisting of: a compound represented by the formula (1); and a compound represented by the formula (2), and wherein the total of the content of the compound represented by the formula (1) and the content of the compound represented by the formula (2) in the charge transporting layer is 1 to 20 ppm with respect to the total mass of the charge transporting layer.

### BACKGROUND

### Field of the Technology

The present disclosure relates to an image forming apparatus using a photosensitive drum.

### Description of the Related Art

An electrophotographic-system image forming apparatus, such as a laser beam printer or a digital copying machine, includes a solid-state exposure head as one of exposure devices that expose a photosensitive drum.

In the solid-state exposure head, light emitting points, such as LEDs and organic EL elements serving as light emitting elements, are arranged in a direction parallel to the rotation shaft of the photosensitive drum (main scanning direction) in a substantially linear manner, and simultaneously expose the photosensitive drum in the main scanning direction. The exposure device of the system has a smaller volume than that of a laser scanning-system exposure device, which performs scanning with a polygon mirror, and has no driving portion, and hence the exposure device is advantageous in miniaturization of the image forming apparatus and reduction in noise.

In Japanese Patent Laid-Open No. 2023-35383, there is a disclosure of an exposure head using an organic EL element as a solid-state exposure head.

Meanwhile, as a drum-shaped electrophotographic photosensitive member (hereinafter also referred to as “photosensitive drum”) mounted on an electrophotographic-system image forming apparatus, a photosensitive drum having a surface containing a thermoplastic resin has been widely used.

In Japanese Patent Laid-Open No. H10-39521, there is a disclosure of a technology concerning a photosensitive drum having a surface layer containing a polymer having a specific constituent unit for improvements in solvent cracking resistance, mechanical strength, and electrical resistance characteristics.

In addition, in Japanese Patent Laid-Open No. 2013-178513, there is a disclosure of a technology concerning a photosensitive drum having a photosensitive layer containing a charge transporting substance having a specific structure and a binder resin having a specific structure for electrical characteristics and cracking resistance characteristics.

When the exposure head using the organic EL element described in Japanese Patent Laid-Open No. 2023-35383 is used as an exposure light source in the photosensitive drum described in Japanese Patent Laid-Open No. H10-39521 or Japanese Patent Laid-Open No. 2013-178513, an image defect may be caused by exposure memory during repeated use.

### SUMMARY

The present disclosure is directed to providing an image forming apparatus that suppresses an image defect caused by exposure memory during repeated use and can stably form an image.

An image forming apparatus according to the present disclosure is an image forming apparatus including: a photosensitive drum; and light emitting elements for emitting exposure light to be applied to a surface of the photosensitive drum, wherein the light emitting elements are each an organic EL element, wherein the photosensitive drum includes a support, a charge generating layer, and a charge transporting layer, wherein the charge transporting layer contains at least one compound selected from the group consisting of: a compound represented by the following formula (1); and a compound represented by the following formula (2), and wherein a total of a content of the compound represented by the formula (1) and a content of the compound represented by the formula (2) in the charge transporting layer is 1 to 20 ppm with respect to a total mass of the charge transporting layer:

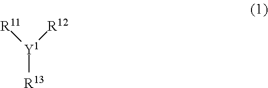

in the formula (1), R¹¹, R¹², and R¹³ each independently represent an alkyl group having 3 to 8 carbon atoms, and Y¹ represents a nitrogen atom or a phosphorus atom;

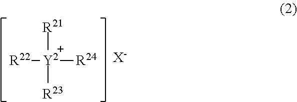

in the formula (2), R²¹, R²², and R²³ each independently represent an alkyl group having 3 to 8 carbon atoms, R²⁴ represents an alkyl group or an alkyl group having an aromatic group as a substituent, X represents a halogen atom, and Y² represents a nitrogen atom or a phosphorus atom.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for illustrating an example of an image forming apparatus used in the present disclosure.

FIG. 2 is a schematic view for illustrating an example of the layer structure of the photosensitive drum used in the present disclosure.

FIG. 3A and FIG. 3B are each a graph showing an example of the emission spectrum of an organic EL element used in the present disclosure.

FIG. 4A and FIG. 4B are schematic views of charts used in evaluation in Examples.

### DESCRIPTION OF THE EMBODIMENTS

The present disclosure is described in detail below by way of exemplary embodiments.

The inventors have made investigations, and as a result, have found that when, in an image forming apparatus that applies exposure light through use of an organic EL element, a photosensitive drum having a charge transporting layer containing a specific compound according to the present disclosure at a specific ratio is used, an image defect caused by exposure memory can be suppressed. That is, the photosensitive drum according to the present disclosure is characterized by containing at least one compound selected from the group consisting of: a compound represented by the following formula (1); and a compound represented by the following formula (2) at a ratio of 1 to 20 ppm on a mass basis with respect to the total mass of the charge transporting layer:

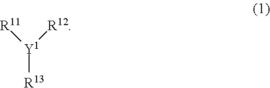

In the formula (1), R¹¹, R¹², and R¹³ each independently represent an alkyl group having 3 to 8 carbon atoms, and Y¹ represents a nitrogen atom or a phosphorus atom;

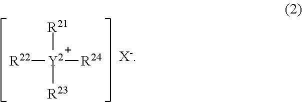

In the formula (2), R²¹, R²², and R²³ each independently represent an alkyl group having 3 to 8 carbon atoms, R²⁴ represents an alkyl group or an alkyl group having an aromatic group as a substituent, X represents a halogen atom, and Y² represents a nitrogen atom or a phosphorus atom.

The inventors have assumed the reasons why a configuration according to the present disclosure can solve the above-mentioned problem to be as described below.

An exposure light source using an organic EL element for a solid-state exposure head has a broad wavelength distribution as compared to an exposure light source using an inorganic LED or a laser. It is conceivable that when a photosensitive drum receives light having a broad wavelength, the excited states of electrons and holes generated in its charge generating layer become non-uniform, and charge transfer in its charge transporting layer also becomes non-uniform. Moreover, when the photosensitive drum is repeatedly exposed, charge in the charge transporting layer may be accumulated to cause exposure memory in some cases.

It is conceivable that in the configuration according to the present disclosure, charge transfer in its charge transporting layer becomes uniform to eliminate charge accumulation, and hence the exposure memory is alleviated.

An image forming apparatus is described below.

### [Image Forming Apparatus]

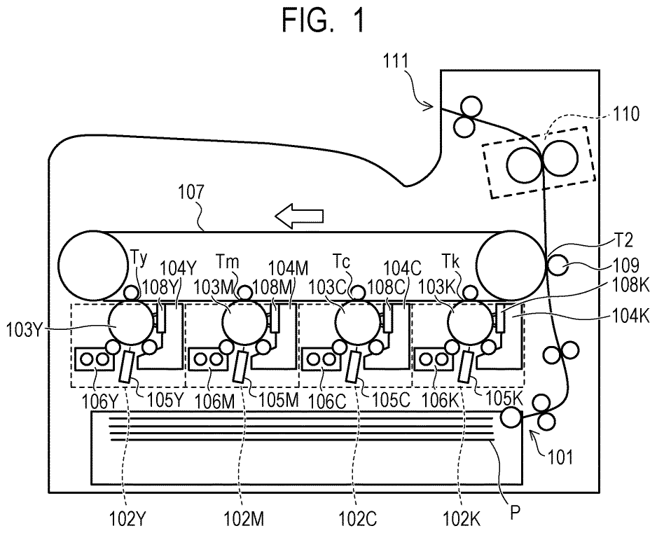

An image forming apparatus illustrated in FIG. 1 includes four image forming portions 102Y, 102M, 102C, and 102K that form a yellow toner image, a magenta toner image, a cyan toner image, and a black toner image, respectively.

The image forming portions 102Y, 102M, 102C, and 102K include photosensitive drums 103Y, 103M, 103C, and 103K, which are rotatable about their rotation shaft lines, respectively. The image forming apparatus includes chargers 104Y, 104M, 104C, and 104K, solid-state exposure heads 105Y, 105M, 105C, and 105K, developing portions 106Y, 106M, 106C, and 106K, and cleaning units 108Y, 108M, 108C, and 108K in the peripheries of the respective photosensitive drums.

The solid-state exposure heads are also simply referred to as “exposure heads.”

### <Image Forming Process>

The photosensitive drums 103Y, 103M, 103C, and 103K uniformly charged by the chargers 104Y, 104M, 104C, and 104K, respectively are irradiated with exposure light by the solid-state exposure heads 105Y, 105M, 105C, and 105K, respectively. Then, the surfaces of the photosensitive drums are exposed to light to form electrostatic latent images. The electrostatic latent images are visualized as toner images of the respective colors by the developing portions 106Y, 106M, 106C, and 106K, and the toner images are transferred at primary transfer portions Ty, Tm, Tc, and Tk onto an intermediate transfer belt 107. The surface of each of the photosensitive drums after the transfer step is cleaned by the removal of a transfer residual developer (transfer residual toner) with the cleaning unit 108Y, 108M, 108C, or 108K.

The toner images of the respective colors superimposed on the intermediate transfer belt 107 are simultaneously transferred with a secondary transfer roller 109 at a secondary transfer portion T2 onto a recording sheet P conveyed from a sheet feeding portion 101. The recording sheet P onto which the toner images are transferred is conveyed to a fuser 110, and then delivered from a sheet delivery portion 111 after the fixation of the toner images under heat and pressure.

### <Organic EL Element>

Light emitting elements of a solid-state exposure head 105 used to emit exposure light to be applied to the surface of a photosensitive drum in the present disclosure are each an organic EL element.

In the present disclosure, an organic EL element in which the wavelength of a peak having the highest emission intensity in an emission spectrum falls within the range of 500 to 700 nm may be suitably used as the organic EL element.

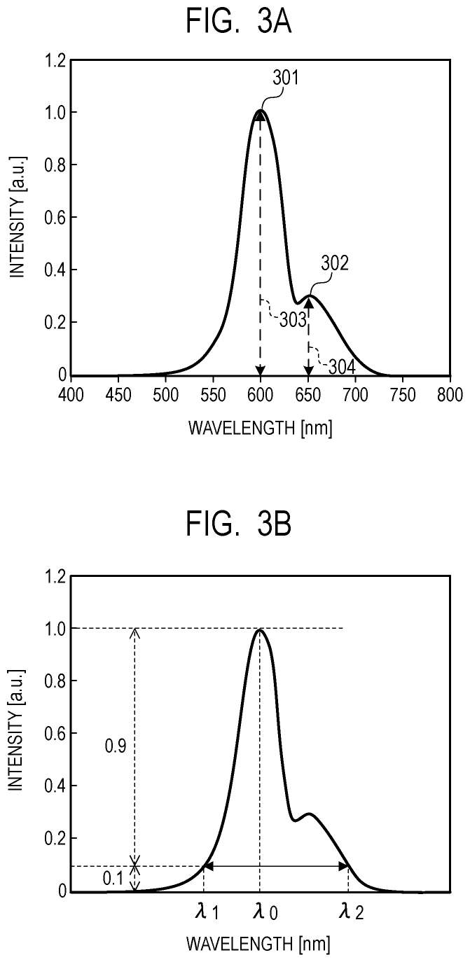

FIG. 3A and FIG. 3B each show an example of the emission spectrum of the organic EL element.

In the example shown in FIG. 3A, the wavelength of a peak 301 having the highest emission peak intensity 303 in the emission spectrum of the organic EL element is 600 nm, and the wavelength of a peak 302 having the second highest emission peak intensity 304 is 650 nm.

As shown in FIG. 3B, the wavelength of the peak having the highest emission intensity in the emission spectrum of the organic EL element used in the present disclosure is represented by λ₀(nm). At this time, the λ₀ is preferably 500 to 700 nm as described above.

In addition, as shown in FIG. 3B, out of wavelengths each having an emission intensity that is 10% of the emission intensity at the λ₀, a wavelength closest to the λ₀ in a wavelength region shorter than the λ₀ is represented by λ₁(nm), and a wavelength closest to the λ₀ in a wavelength region longer than the λ₀ is represented by λ₂ (nm). At this time, 80≤λ₂−λ₁≤150 is preferably satisfied.

An exposure head having a light emitting substrate having a light emitting chip in which the organic EL elements according to the present disclosure are arranged may be used in the present disclosure.

In the present disclosure, an organic EL element that satisfies the following condition may be suitably used: the wavelength of the peak having the highest emission intensity in the emission spectrum falls within the range of 500 to 700 nm. Such organic EL element is specifically as described below. That is, out of the organic EL elements (=light emitting elements), 80% by number or more of the organic EL elements each preferably have a wavelength of the peak having the highest emission intensity in the emission spectrum falling within the range of 500 to 700 nm. In addition, the ratio of the organic EL elements each satisfying the above-mentioned condition out of the organic EL elements is more preferably 90% by number or more, still more preferably 95% by number or more, most preferably 100% by number.

The organic EL elements used in the present disclosure each preferably have peaks in the emission spectrum. In addition, when the organic EL elements each have peaks in the emission spectrum, it is more preferred that the emission intensity of the peak having the highest emission intensity be three or more times as high as the emission intensity of the peak having the second highest emission intensity.

Examples of a light emitting material, which is used in the organic EL elements according to the present disclosure and is mainly involved in a light emitting function, include fused-ring compounds (e.g., a fluorene derivative, a naphthalene derivative, a pyrene derivative, a perylene derivative, a tetracene derivative, an anthracene derivative, and rubrene), a quinacridone derivative, a coumarin derivative, a stilbene derivative, organoaluminum complexes, such as tris(8-quinolinolato)aluminum, an iridium complex, a platinum complex, a rhenium complex, a copper complex, an europium complex, a ruthenium complex, and polymer derivatives, such as a poly(phenylene vinylene) derivative, a poly(fluorene) derivative, and a poly(phenylene) derivative. Of those, a perylene derivative is preferred. Specific examples of the compound used as the light emitting material are given below, but the present disclosure is not limited thereto.

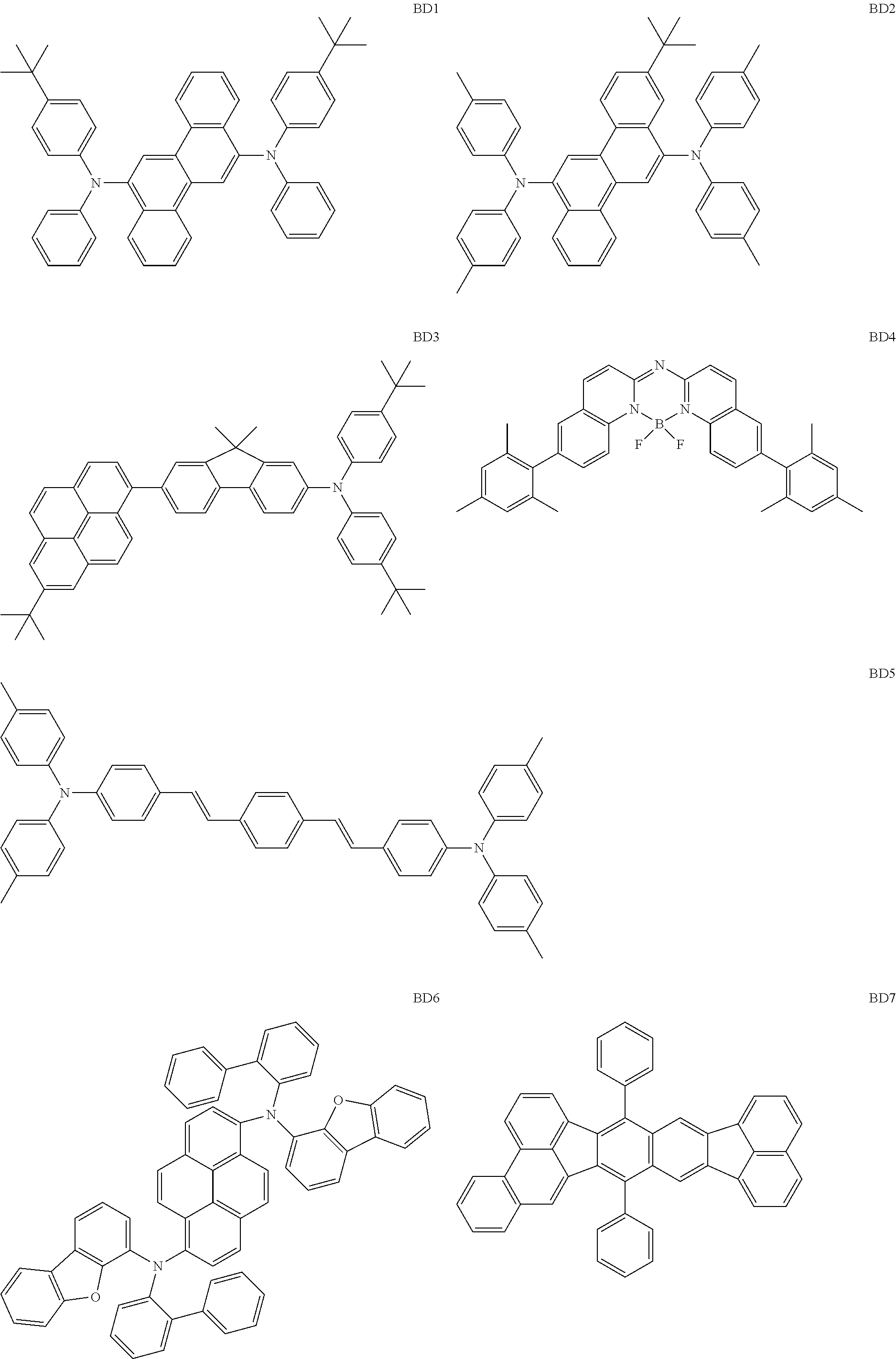

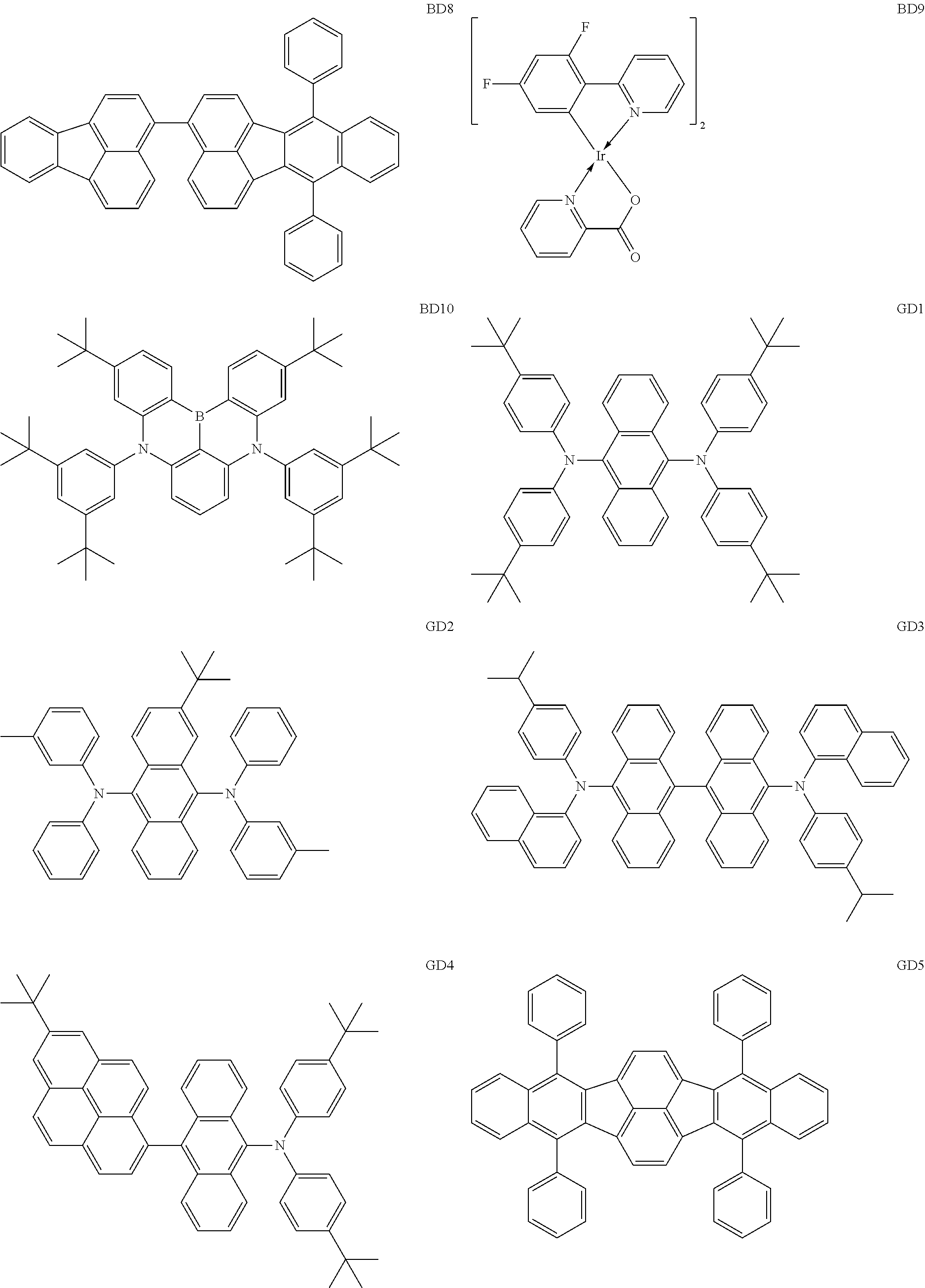

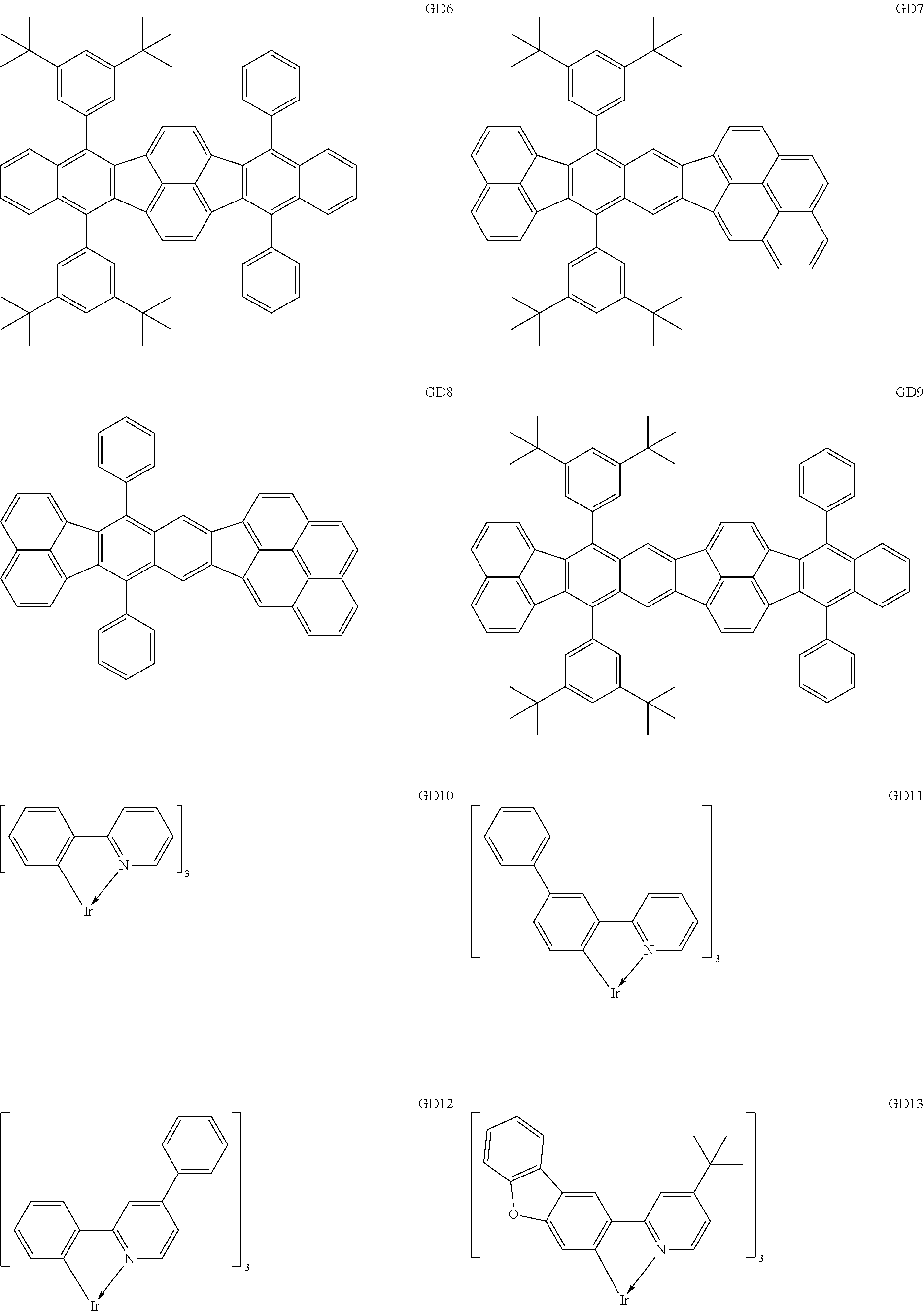

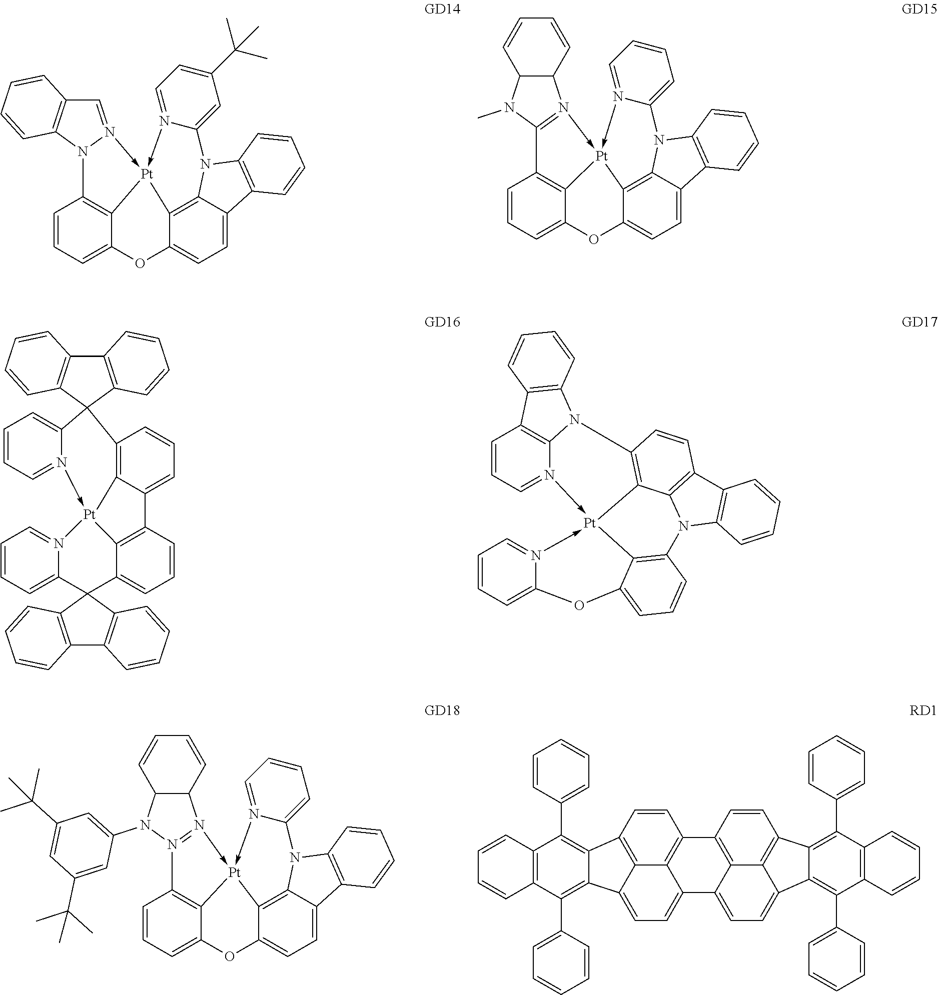

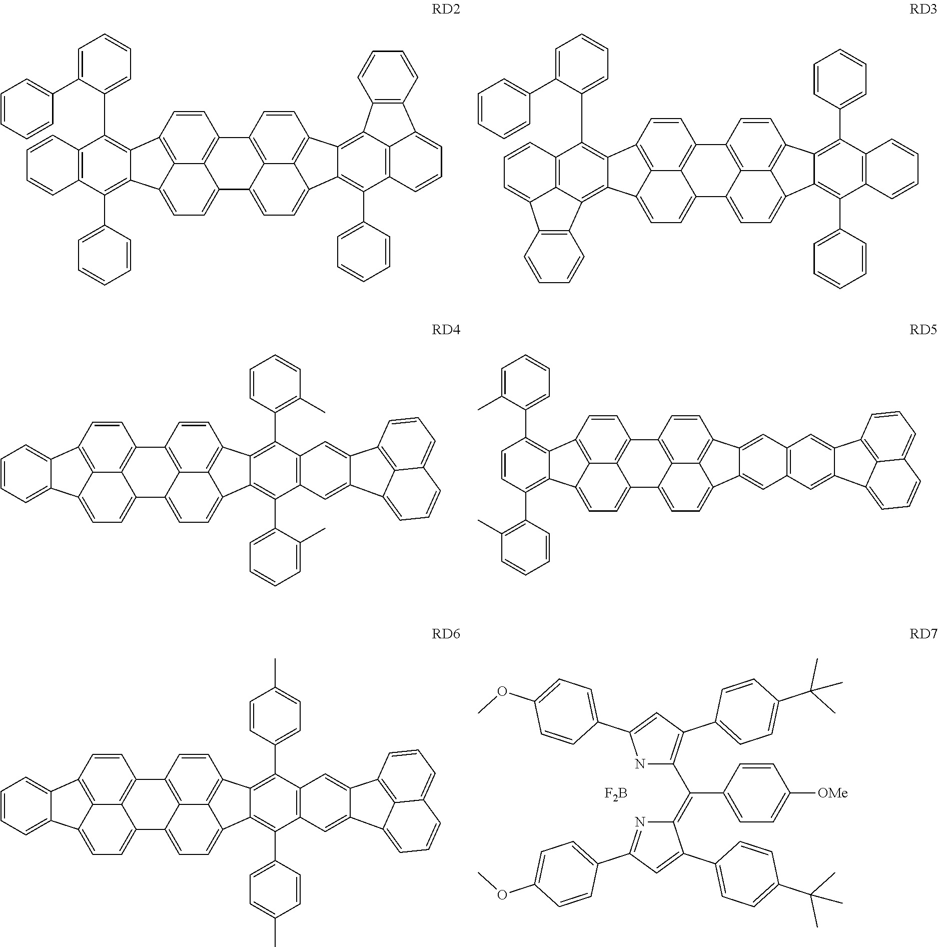

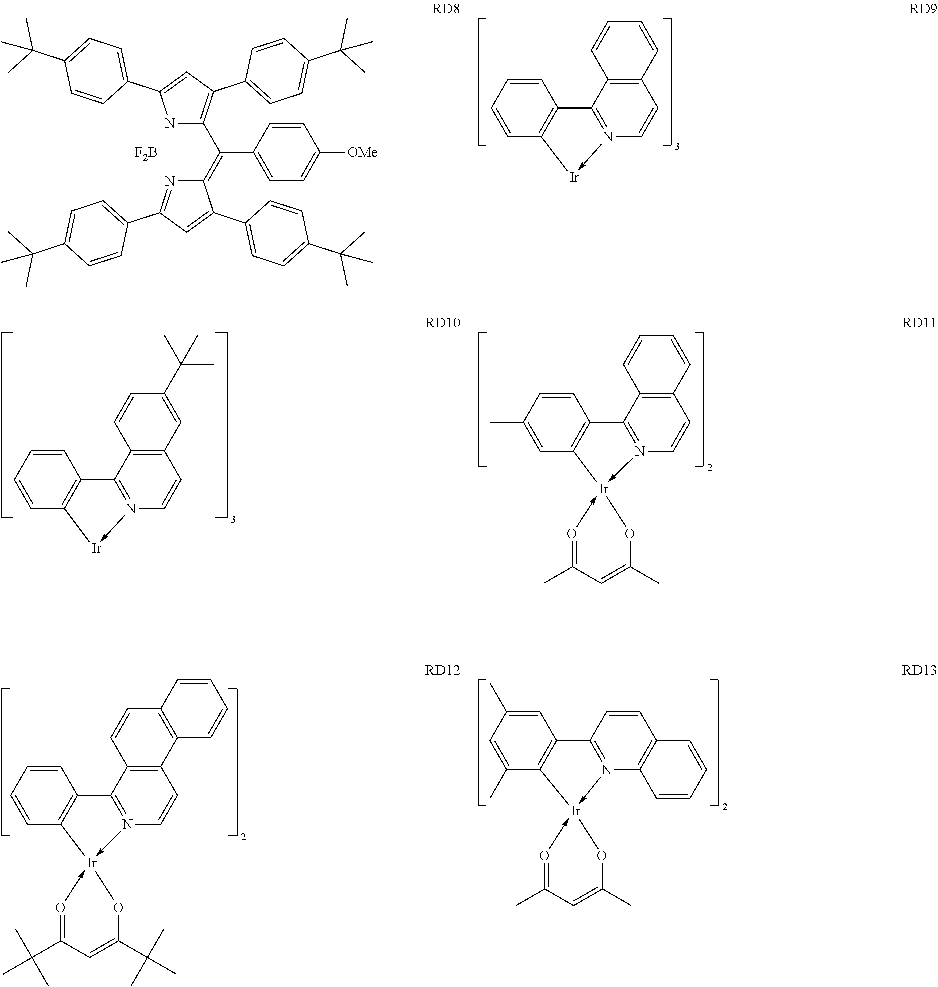

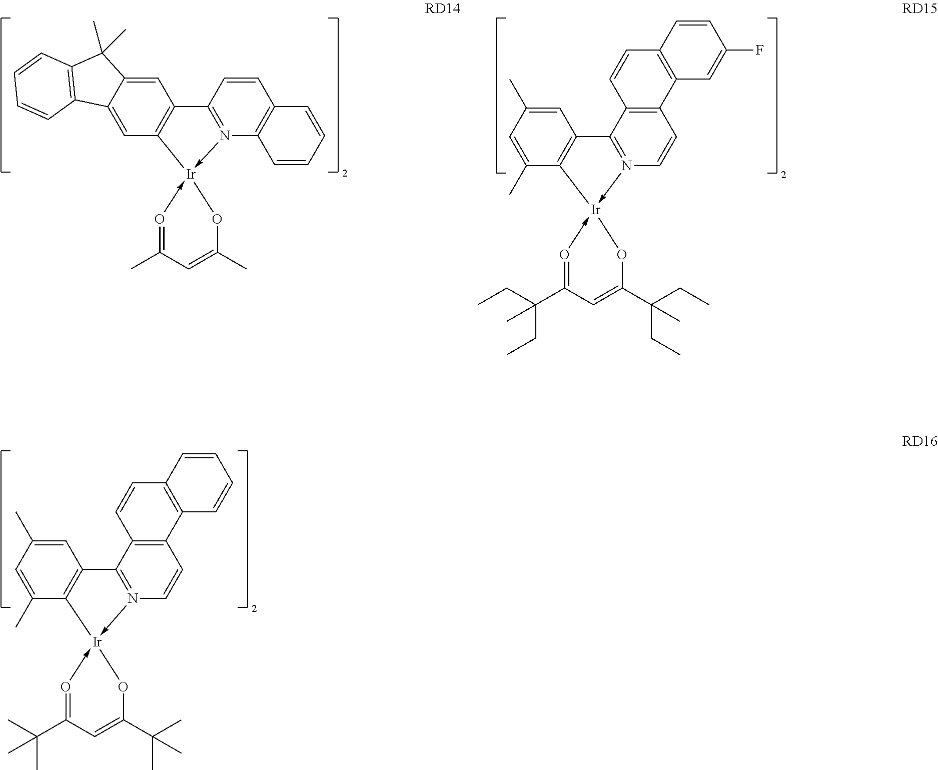

Specific examples of a host or an assist incorporated into the light emitting layer of each of the organic EL elements include, but not limited to, an aromatic hydrocarbon compound or a derivative thereof, a carbazole derivative, an azine derivative, a xanthone derivative, a dibenzofuran derivative, a dibenzothiophene derivative, organoaluminum complexes, such as tris(8-quinolinolato)aluminum, and an organic beryllium complex. Specific examples thereof are given below.

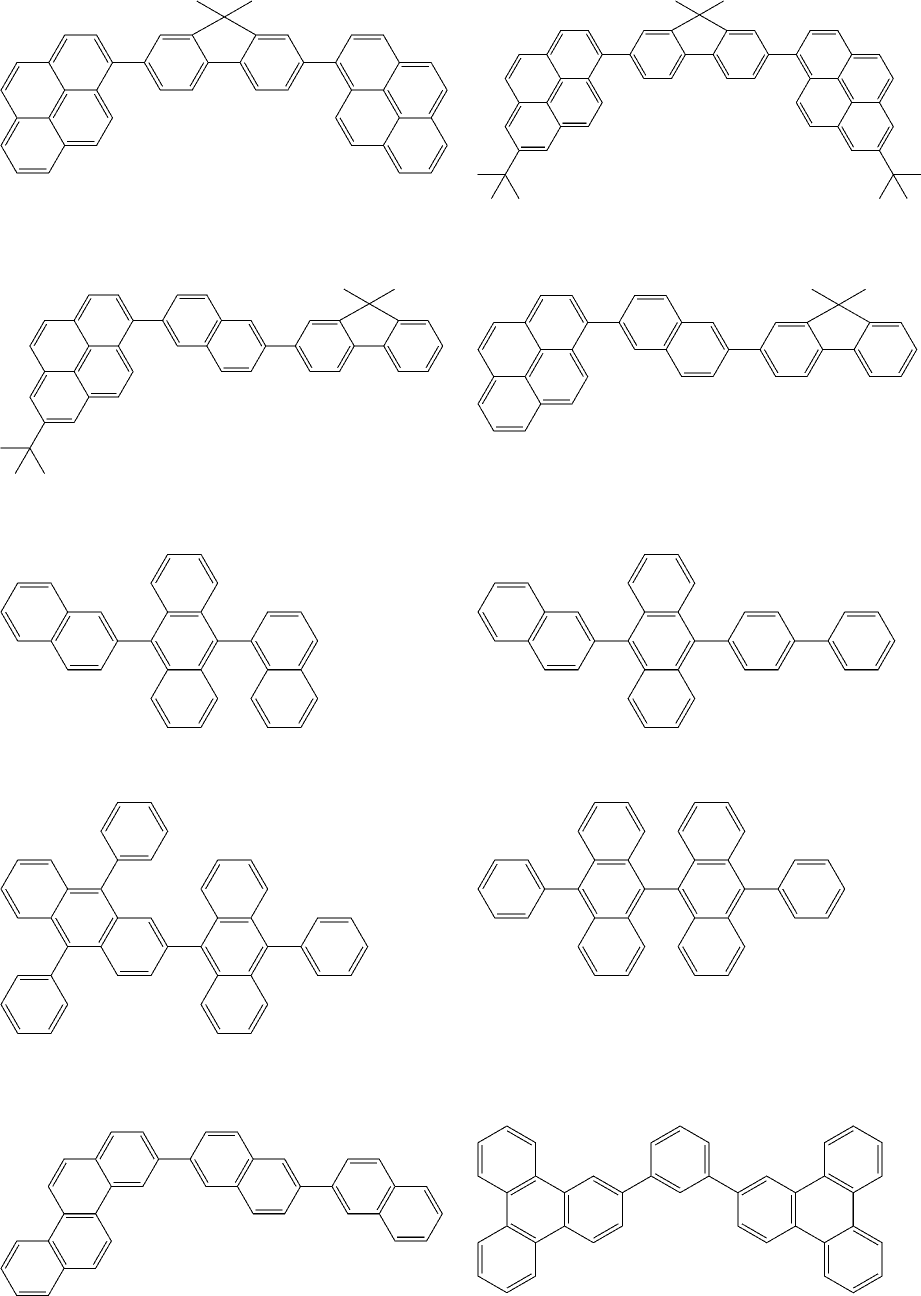

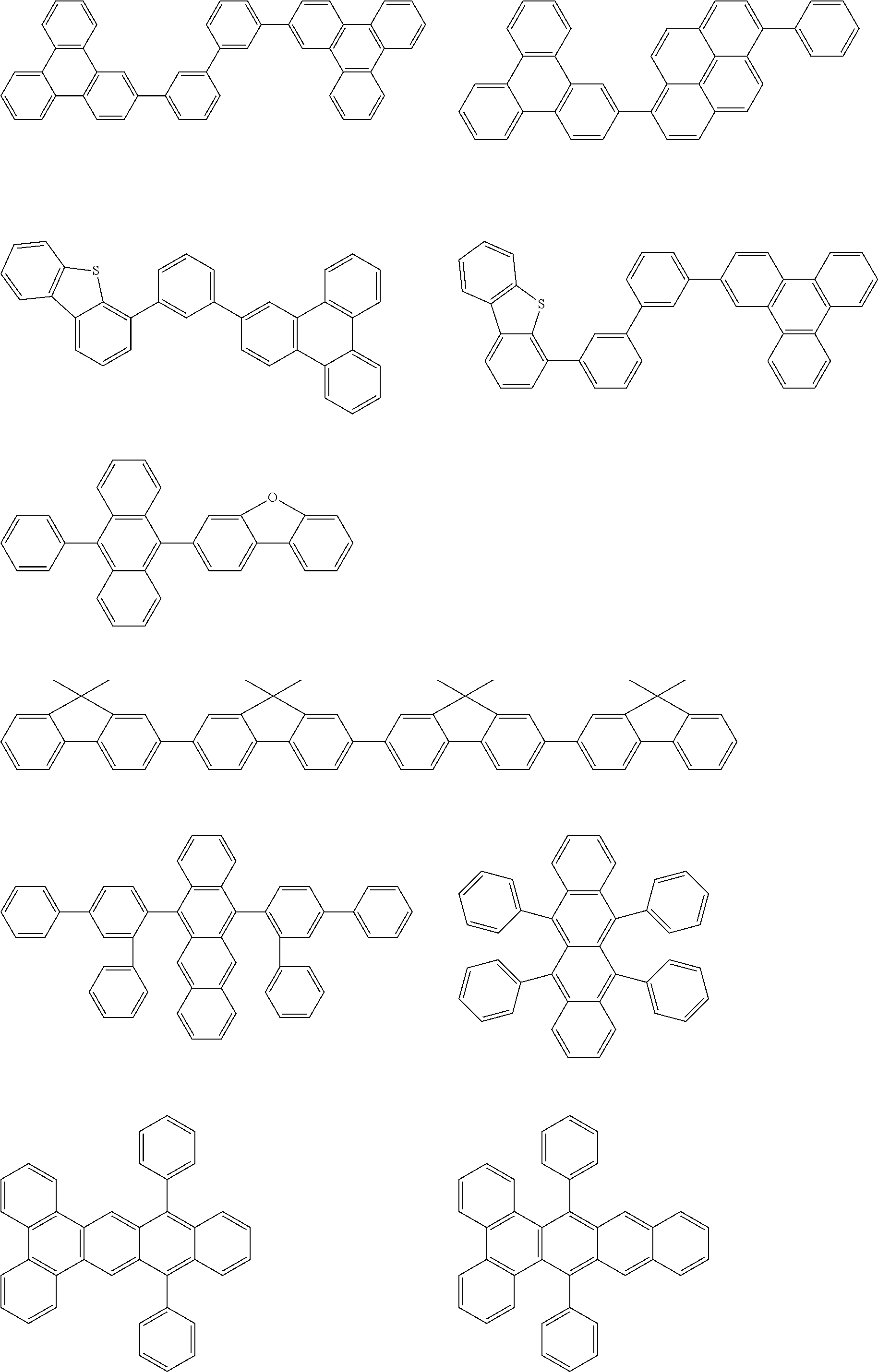

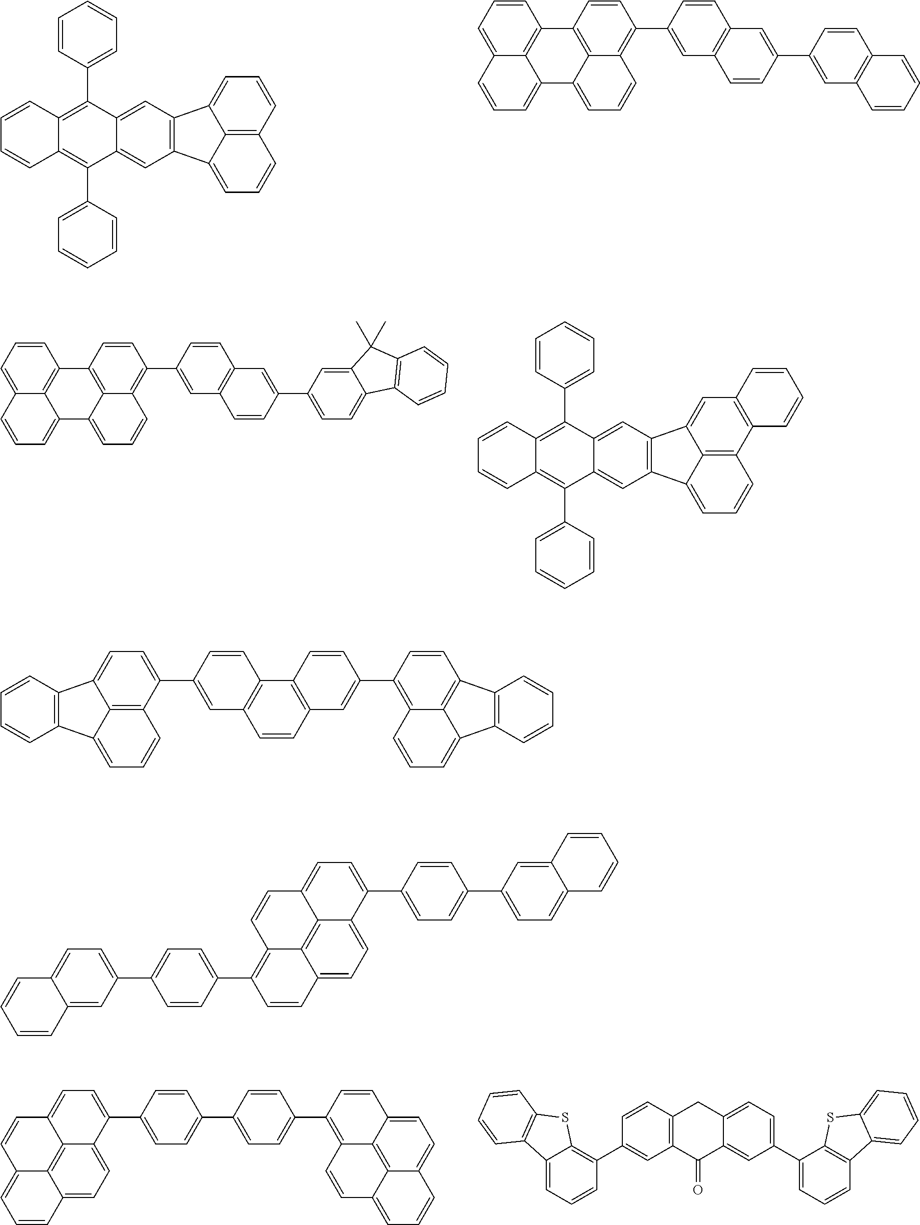

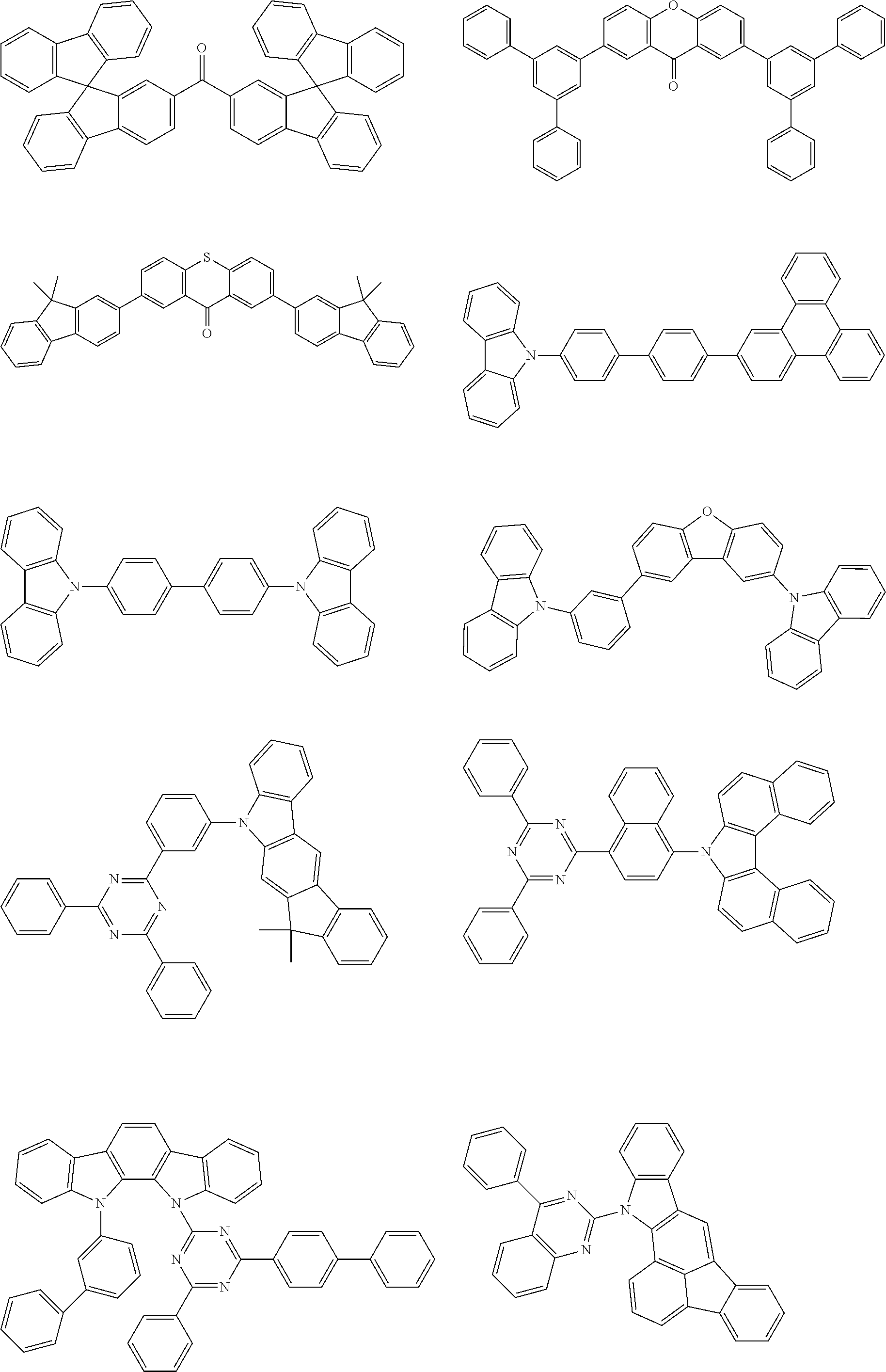

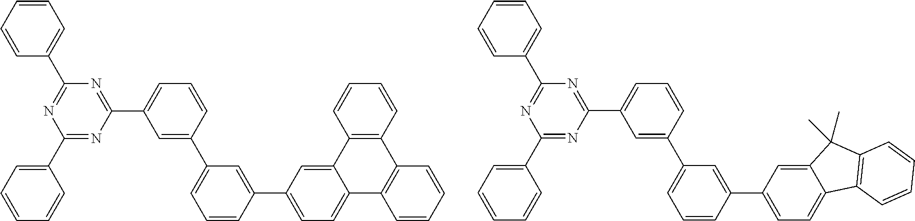

The photosensitive drum is described below.

### [Photosensitive Drum]

The photosensitive drum according to the present disclosure includes a laminate-type photosensitive layer in which a charge generating layer and a charge transporting layer are laminated in the stated order.

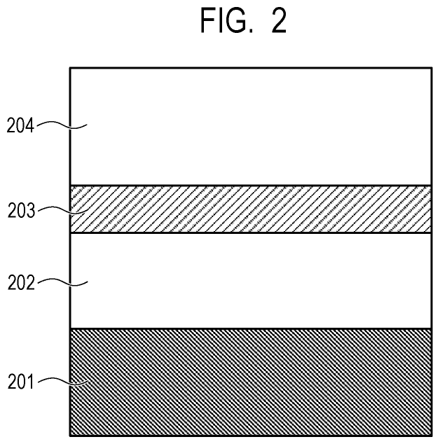

FIG. 2 is a schematic view for illustrating an example of the layer structure of each of the photosensitive drums 103Y, 103M, 103C, and 103K used in the present disclosure. The layer structure of the photosensitive drum illustrated in FIG. 2 includes a support 201, an undercoat layer 202, a charge generating layer 203, and a charge transporting layer 204.

In the present disclosure, the photosensitive drum means a drum-shaped electrophotographic photosensitive member.

### <Support>

The support is preferably a support having electroconductivity (electroconductive support), and examples thereof include: supports made of metals (alloys), such as aluminum, iron, copper, gold, stainless steel, and nickel; and metal or insulator supports each having an electroconductive film on its surface. The insulator support is, for example, a support made of a plastic, such as a polyester resin, a polycarbonate resin, or a polyimide resin, glass, or paper. In addition, examples of the electroconductive film include: thin films of metals, such as aluminum, chromium, silver, and gold; thin films of electroconductive materials, such as indium oxide, tin oxide, and zinc oxide; and an electroconductive ink thin film including a silver nanowire.

The support in the present disclosure has a cylindrical shape. An aluminum-made cylindrical support is excellent in mechanical strength, electrophotographic characteristics, and cost. In addition, a base pipe may be used as the support as it is, or a base pipe having a surface that is subjected to, for example, physical treatment, such as cutting, honing, or blasting treatment, anodic oxidation treatment, or chemical treatment with an acid or the like for improvements in electrical characteristics and the suppression of an interference pattern may be used as the support.

### <Electroconductive Layer>

An electroconductive layer is a layer that may be arranged as required.

The electroconductive layer is a layer that may be arranged on the electroconductive support, and between the electroconductive support and the photosensitive layer, more specifically in an order of the electroconductive support, the electroconductive layer, the undercoat layer, and the photosensitive layer.

When the electroconductive layer is arranged, flaws and unevenness in the surface of the electroconductive support can be concealed, and the reflection of light on the surface of the support can be controlled.

The electroconductive layer contains electroconductive particles and a binder resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, strontium titanate, magnesium oxide, antimony oxide, and bismuth oxide.

Examples of the metal out of the materials include aluminum, nickel, iron, nichrome, copper, zinc, and silver.

Of the above-mentioned materials for the electroconductive particles, the metal oxide is preferred, and in particular, titanium oxide, tin oxide, or zinc oxide is more preferred.

In addition, with regard to the metal oxide, the metal oxide may have a surface treated with a silane coupling agent or the like, or the metal oxide may be doped with an element itself, such as phosphorus or aluminum, or an oxide thereof.

In addition, the electroconductive particles may each have a laminated configuration including a core and a coating layer coating the core. Examples of the core include titanium oxide, barium sulfate, and zinc oxide. The coating layer is, for example, a metal oxide such as tin oxide.

When the thickness of the coating layer and that of the above-mentioned surface treated with the silane coupling agent are compared to each other, the former is much larger than the latter.

In addition, when the metal oxide is used as the electroconductive particles, their volume-average particle diameter is preferably 1 to 500 nm, more preferably 3 to 400 nm.

Examples of the binder resin include a polyester resin, a polycarbonate resin, a polyvinyl acetal resin, an acrylic resin, a silicone resin, an epoxy resin, a melamine resin, a polyurethane resin, a phenol resin, and an alkyd resin.

The electroconductive layer may further contain, for example, a silicone oil, resin particles, or a concealing agent such as titanium oxide.

The electroconductive layer may be obtained by arranging, on the support, a coating film of a coating liquid for an electroconductive layer containing the above-mentioned materials and a solvent, and drying the coating film.

Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

A dispersion method for dispersing the electroconductive particles in the coating liquid for an electroconductive layer is, for example, a method including using a paint shaker, a sand mill, a ball mill, or a liquid collision-type high-speed disperser.

The average thickness of the electroconductive layer is preferably 0.1 to 50 μm, particularly preferably 3 to 40 μm.

### <Undercoat Layer>

An undercoat layer having a barrier function and an adhesion function may be arranged on the support or the electroconductive layer as required. The undercoat layer is obtained by dissolving a resin in a solvent to prepare a coating liquid for an undercoat layer, forming a coating film of the coating liquid for an undercoat layer, and drying the coating film. The undercoat layer contains a binder resin and a substance that improves its electrical characteristics. The resin and the substance are each described.

The undercoat layer contains the binder resin. In addition, the undercoat layer may be obtained as a cured film that is formed from a coating liquid by polymerizing a composition containing a monomer having a polymerizable functional group in the coating liquid (cured by polymerizing the monomer).

Examples of the binder resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may contain an electron transporting substance, a metal oxide, a metal, or the like for the purpose of improving its electrical characteristics. Of those, an electron transporting substance or a metal oxide is preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a compound containing boron. An electron transporting substance having a polymerizable functional group may be used as the electron transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, strontium titanate, and silicon dioxide. Examples of the metal include gold, silver, and aluminum.

The metal oxide to be incorporated into the undercoat layer may be subjected to surface treatment with a surface treatment agent such as a silane coupling agent before use.

A general method is used as a method of subjecting the metal oxide to the surface treatment. Examples thereof include a dry method and a wet method.

The dry method involves, while stirring the metal oxide in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method involves stirring the metal oxide and the surface treatment agent in a solvent, or dispersing the metal oxide and the surface treatment agent in the solvent with a sand mill or the like using glass beads or the like. After the dispersion, the solvent is removed by filtration or evaporation under reduced pressure. After the removal of the solvent, it is preferred to further perform baking at 100 °C or more.

The undercoat layer may further contain an additive, and for example, may contain a known material, such as: metal powder such as aluminum; an electroconductive substance such as carbon black; a metal chelate compound; an organometallic compound; or an electron transporting material such as an azo-based material.

The undercoat layer may be formed by preparing a coating liquid for an undercoat layer containing the above-mentioned materials and a solvent, forming a coating film thereof on the support or the electroconductive layer, and drying and/or curing the coating film.

Examples of the solvent to be used in the coating liquid for an undercoat layer include organic solvents, such as an alcohol, a sulfoxide, a ketone, an ether, an ester, an aliphatic halogenated hydrocarbon, and an aromatic compound. In the present disclosure, an alcohol-based or ketone-based solvent is preferably used.

A dispersion method for preparing the coating liquid for an undercoat layer is, for example, a method including using a homogenizer, an ultrasonic disperser, a ball mill, a sand mill, a roll mill, a vibration mill, an attritor, or a liquid collision-type high-speed disperser.

When the undercoat layer is used, its average thickness is preferably 0.05 to 50 m, more preferably 0.3 to 25 μm.

### <Charge Generating Layer>

The charge generating layer preferably contains a charge generating substance and a binder resin.

Examples of the charge generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

From the viewpoint of suppressing exposure memory, a hydroxygallium phthalocyanine pigment or a chlorogallium phthalocyanine pigment is particularly preferred. That is, the charge generating layer preferably contains a hydroxygallium phthalocyanine compound or a chlorogallium phthalocyanine compound.

The content of the charge generating substance in the charge generating layer is preferably 40 to 85 mass %, more preferably 60 to 80 mass % with respect to the total mass of the charge generating layer.

Examples of the binder resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The average thickness of the charge generating layer is preferably 0.1 to 1 μm, more preferably 0.15 to 0.4 μm.

The charge generating layer may be formed by preparing a coating liquid for a charge generating layer containing the above-mentioned materials and a solvent, forming a coating film thereof, and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### <Charge Transporting Layer>

The charge transporting layer contains at least one compound selected from the group consisting of: a compound represented by the following formula (1); and a compound represented by the following formula (2). In addition, the total of the content of the compound represented by the formula (1) and the content of the compound represented by the formula (2) in the charge transporting layer is 1 to 20 ppm with respect to the total mass of the charge transporting layer. The total mass of the charge transporting layer represents the total mass of solids for forming the charge transporting layer.

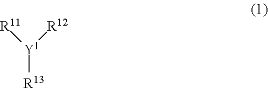

In the formula (1), R¹¹, R¹², and R¹³ each independently represent an alkyl group having 3 to 8 carbon atoms, and Y¹ represents a nitrogen atom or a phosphorus atom.

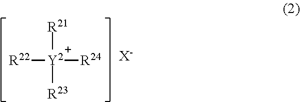

In the formula (2), R²¹, R²², and R²³ each independently represent an alkyl group having 3 to 8 carbon atoms, R²⁴ represents an alkyl group or an alkyl group having an aromatic group as a substituent, X represents a halogen atom, and Y² represents a nitrogen atom or a phosphorus atom.

Y¹ in the formula (1) preferably represents a nitrogen atom, and Y² in the formula (2) preferably represents a nitrogen atom.

In addition, the charge transporting layer preferably contains the compound represented by the formula (1).

In the present disclosure, the charge transporting layer preferably contains a charge transporting substance and a binder resin.

Examples of the charge transporting substance include: quinone-based compounds, such as p-benzoquinone, chloranil, bromanil, and anthraquinone; a tetracyanoquinodimethane-based compound; fluorenone compounds, such as 2,4,7-trinitrofluorenone; a xanthone-based compound; a benzophenone-based compound; a cyanovinyl-based compound; and an ethylenic compound. Examples of the charge transporting substance also include a triarylamine-based compound, a benzidine-based compound, an arylalkane-based compound, an aryl-substituted ethylenic compound, a stilbene-based compound, an anthracene-based compound, and a hydrazone-based compound. Examples of the charge transporting substance further include a polycyclic aromatic compound, a heterocyclic compound, a hydrazone compound, a styryl compound, an enamine compound, a triarylamine compound, and a resin having a group derived from each of those substances. Those charge transporting substances may be used alone or in combination thereof, but the present disclosure is not limited thereto. Of those, a triarylamine compound is preferred.

The content of the charge transporting substance in the charge transporting layer is preferably 25 to 70 mass %, more preferably 30 to 55 mass % with respect to the total mass of the charge transporting layer.

Examples of the binder resin include a polycarbonate resin, a polyester resin, an acrylic resin, and a polystyrene resin. Of those, a polyester resin and a polycarbonate resin are preferred, and a polyester resin is particularly preferred. The charge transporting layer may contain kinds of resins.

When a polyester resin is used, the polyester resin preferably has a structure represented by the following formula (a) and a structure represented by the following formula (b).

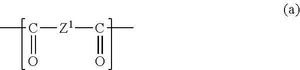

In the formula (a), Z¹ represents a m-phenylene group unsubstituted or substituted by one or more methyl groups, a p-phenylene group unsubstituted or substituted by one or more methyl groups, a divalent group in which two m-phenylene groups or p-phenylene groups are bonded to each other via an oxygen atom, or a naphthylene group.

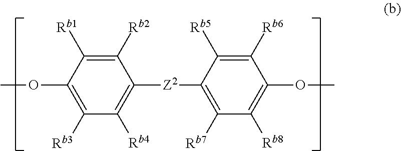

In the formula (b), Z² represents a single bond, an oxygen atom, an alkylidene group, or a cycloalkylidene group, and R^{b1} to R^{b8} each independently represent a hydrogen atom or an alkyl group.

R^{b1} to R^{b8} in the formula (b) each preferably represent a hydrogen atom or a methyl group.

In addition, when Z² in the formula (b) represents an alkylidene group, the number of carbon atoms of the alkylidene group represented by Z² is preferably 1 to 3. In addition, when Z² represents a cycloalkylidene group, the number of carbon atoms of the cycloalkylidene group represented by Z² is preferably 6.

The polyester resin may be a copolymer containing at least one of: two or more kinds of structural units derived from two or more kinds of diol monomers; or two or more kinds of structural units derived from two or more kinds of dicarboxylic acid monomers. In this case, the copolymerization form of the polyester resin may be any appropriate form, such as a block copolymerization form, a random copolymerization form, or an alternating copolymerization form. Of those, a random copolymer is preferred because high abrasion resistance and scratch resistance are obtained.

Examples of the structure represented by the formula (a) of the polyester resin include structures derived from carboxylic acids, such as terephthalic acid, isophthalic acid, biphenyldicarboxlic acid, aliphatic dicarboxylic acid, and naphthalenedicarboxylic acid. Specific examples thereof include the following structures.

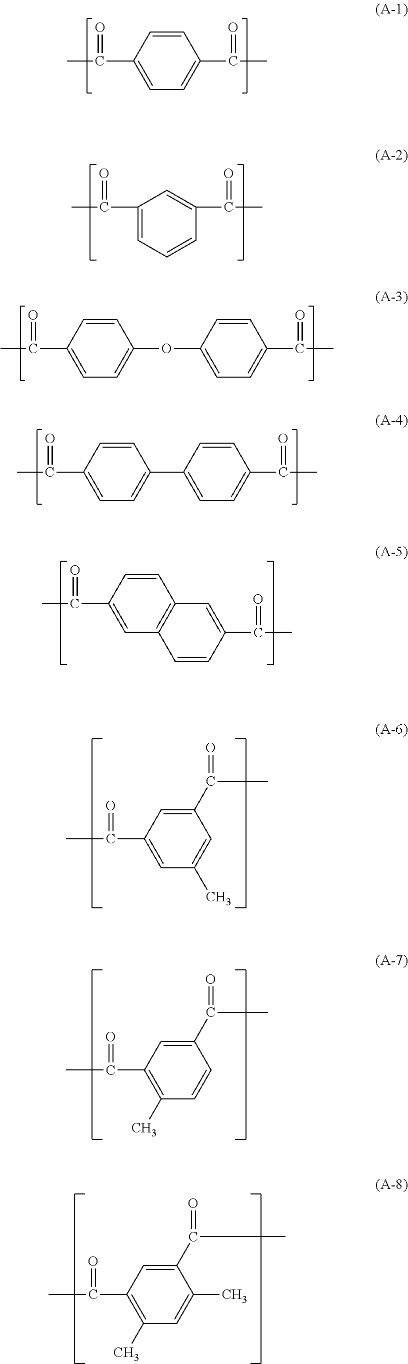

In addition, specific examples of the structure represented by the formula (b) of the polyester resin include the following structures.

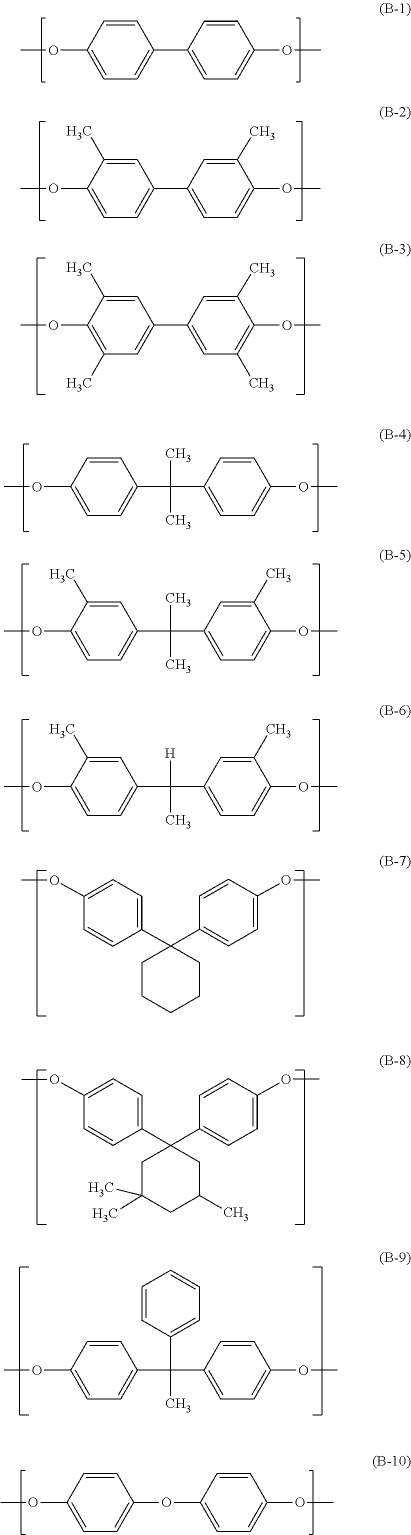

Those polyester resins may each be synthesized by a publicly known method.

In addition, the charge transporting layer may contain an additive, such as an antioxidant, a UV absorber, a plasticizer, a leveling agent, or a lubricant. Specific examples of the additive include a hindered phenol compound, a hindered amine compound, a sulfur compound, a phosphorus compound, a benzophenone compound, a siloxane-modified resin, a silicone oil, fluorocarbon resin particles, polystyrene resin particles, polyethylene resin particles, silica particles, alumina particles, and boron nitride particles.

The average thickness of the charge transporting layer is preferably 5 to 50 μm, particularly preferably 15 to 30 μm.

The charge transporting layer may be formed by preparing a coating liquid for a charge transporting layer containing the above-mentioned materials and a solvent, forming a coating film thereof on the charge generating layer, and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### EXAMPLES

The present disclosure is described in more detail below with reference to specific examples. However, the present disclosure is not limited to these examples. In the following description, the term “part(s)” means “part(s) by mass.”

### <Synthesis of Binder Resin for Charge Transporting Layer>

A polyester resin 1, a polyester resin 2, a polyester resin 3, and a polyester resin 4 were synthesized by the following methods.

### Synthesis Example 1

33.2 g of a mixture including terephthalic acid chloride and isophthalic acid chloride at a molar ratio of 1/1 was dissolved in 700 mL of dichloromethane to prepare an acid halide solution. In addition, 31.9 g of a diol represented by the following formula (b1) and 14.5 g of a diol represented by the following formula (b2) were separately dissolved in 1,400 mL of a 10% sodium hydroxide aqueous solution. 0.43 g of benzyl tri-n-ethylammonium chloride (manufactured by Lion Specialty Chemicals Co., Ltd., “BTEAC-50”) was added as a polymerization catalyst to the solution, and the mixture was stirred to prepare a diol compound solution.

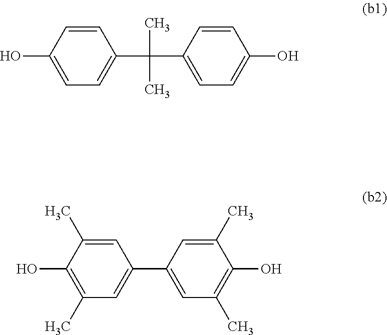 [SMILES: CC(C)(c1ccc(O)cc1)c1ccc(O)cc1 ; Cc1cc(-c2cc(C)c(O)c(C)c2)cc(C)c1O]

Next, polymerization was initiated by adding the above-mentioned acid halide solution to the above-mentioned diol compound solution while stirring the mixture. The polymerization was performed for 3 hours at a reaction temperature kept to 25 °C or less while the mixture was stirred. 0.46 g of p-tert-butylphenol was added as a polymerization modifier during the polymerization reaction. After that, acetic acid was added to terminate the polymerization reaction, and the resultant was repeatedly washed with water 10 times. After the washing, an organic phase was added dropwise to n-hexane under stirring to precipitate a polymerized product, and the polymerized product was dried at 120 °C for 1 day to provide a polyester resin 1.

The resultant polyester resin 1 had 50 mol % of the structure represented by the formula (A-1) and 50 mol % of the structure represented by the formula (A-2) as the structures each represented by the formula (a). In addition, the polyester resin 1 was a polyester resin having 70 mol % of the structure represented by the formula (B-4) and 30 mol % of the structure represented by the formula (B-3) as the structures each represented by the formula (b). The resultant polyester resin 1 was compositionally analyzed for its polymerization ratio by nuclear magnetic resonance spectroscopy.

In addition, the weight-average molecular weight of the resultant polyester resin 1 was 60,000. The molecular weight and molecular weight distribution of the resultant polyester resin 1 were measured by using a chromatogram through gel permeation chromatography (GPC) based on a method described in Japanese Patent No. 3825852.

### Synthesis Example 2

51.6 g of a compound represented by the following formula (al) was dissolved in 700 mL of dichloromethane to prepare an acid halide solution. In addition, 48.4 g of a diol represented by the following formula (b3) was separately dissolved in 1,400 mL of a 10% sodium hydroxide aqueous solution. 0.43 g of benzyl tri-n-ethylammonium chloride (Lion Specialty Chemicals Co., Ltd., “BTEAC-50”) was added as a polymerization catalyst to the solution, and the mixture was stirred to prepare a diol compound solution.

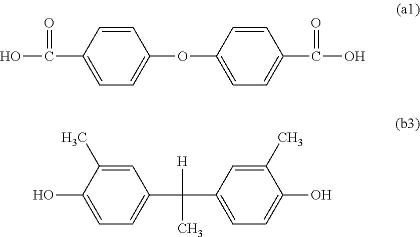 [SMILES: O=C(O)c1ccc(Oc2ccc(C(=O)O)cc2)cc1 ; Cc1cc(C(C)c2ccc(O)c(C)c2)ccc1O]

Next, polymerization was initiated by adding the above-mentioned acid halide solution to the above-mentioned diol compound solution while stirring the mixture. The polymerization was performed for 3 hours at a reaction temperature kept to 25 °C or less while the mixture was stirred. 0.46 g of p-tert-butylphenol was added as a polymerization modifier during the polymerization reaction. After that, acetic acid was added to terminate the polymerization reaction, and the resultant was repeatedly washed with water 10 times. After the washing, an organic phase was added dropwise to n-hexane under stirring to precipitate a polymerized product, and the polymerized product was dried at 120 °C for 1 day to provide a polyester resin 2.

The resultant polyester resin 2 had 100 mol % of the structure represented by the formula (A-3) as the structure represented by the formula (a). In addition, the polyester resin 2 was a polyester resin having 100 mol % of the structure represented by the formula (B-6) as the structure represented by the formula (b). The polyester resin 2 was compositionally analyzed for its polymerization ratio by nuclear magnetic resonance spectroscopy.

In addition, the weight-average molecular weight of the resultant polyester resin 2 was 77,000. The molecular weight and molecular weight distribution of the polyester resin 2 were measured by using a chromatogram through gel permeation chromatography (GPC) based on a method described in Japanese Patent No. 3825852.

### Synthesis Example 3

A polyester resin 3 was obtained by performing synthesis in the same manner as in Synthesis Example 1 except that, in Synthesis Example 1, 31.9 g of the diol represented by the formula (b1) was changed to 35.8 g of a diol represented by the following formula (b4).

The resultant polyester resin 3 had 50 mol % of the structure represented by the formula (A-1) and 50 mol % of the structure represented by the formula (A-2) as the structures each represented by the formula (a). In addition, the polyester resin 3 was a polyester resin having 70 mol % of the structure represented by the formula (B-5) and 30 mol % of the structure represented by the formula (B-3) as the structures each represented by the formula (b). The polyester resin 3 was compositionally analyzed for its polymerization ratio by nuclear magnetic resonance spectroscopy.

In addition, the weight-average molecular weight of the resultant polyester resin 3 was 62,000. The molecular weight and molecular weight distribution of the polyester resin 3 were measured by using a chromatogram through gel permeation chromatography (GPC) based on a method described in Japanese Patent No. 3825852.

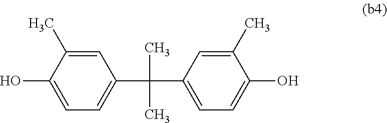 [SMILES: Cc1cc(C(C)(C)c2ccc(O)c(C)c2)ccc1O]

### Synthesis Example 4

A polyester resin 4 was obtained by performing synthesis in the same manner as in Synthesis Example 1 except that, in Synthesis Example 1, 31.9 g of the diol represented by the formula (b1) was changed to 33.9 g of the diol represented by the formula (b3).

The resultant polyester resin 4 had 50 mol % of the structure represented by the formula (A-1) and 50 mol % of the structure represented by the formula (A-2) as the structures each represented by the formula (a). In addition, the polyester resin 4 was a polyester resin having 70 mol % of the structure represented by the formula (B-6) and 30 mol % of the structure represented by the formula (B-3) as the structures each represented by the formula (b). The polyester resin 4 was compositionally analyzed for its polymerization ratio by nuclear magnetic resonance spectroscopy.

In addition, the weight-average molecular weight of the resultant polyester resin 4 was 61,000. The molecular weight and molecular weight distribution of the polyester resin 4 were measured by using a chromatogram through gel permeation chromatography (GPC) based on a method described in Japanese Patent No. 3825852.

### <Production of Photosensitive Drum>

[Method of producing Photosensitive Drum 1]

### (Support)

A product obtained by cutting a cylindrical aluminum cylinder (JIS-A3003, aluminum alloy, outer diameter: 30 mm, length: 357.5 mm, wall thickness: 0.7 mm) was used as a support (electroconductive support). The support was subjected to ultrasonic cleaning in a cleaning liquid obtained by incorporating a detergent (product name: CHEMICOL CT, manufactured by Tokiwa Chemical Industries Co., Ltd.) into pure water, and subsequently, the cleaning liquid was washed off After that, the cleaned product was further subjected to ultrasonic cleaning in pure water to be subjected to degreasing treatment. The resultant was used as a support.

### (Electroconductive Layer)

The following materials were prepared.
Titanium oxide particles each having a coating layer: 57 parts (product name: PASSTRAN LRS, manufactured by Mitsui Mining & Smelting Co., Ltd.)
Resol-type phenolic resin: 35 parts (product name: PHENOLITE J-325, manufactured by DIC Corporation (formerly: Dainippon Ink and Chemicals, Inc.), a methanol solution having a solid content of 60%)
2-Methoxy-1-propanol: 33 parts

The materials were dispersed with a sand mill using glass beads each having a diameter of 1 mm for 3 hours to prepare a dispersion liquid. The average particle diameter of powder incorporated into the dispersion liquid was 0.30 μm. A liquid in which 8 parts of a silicone resin (product name: Tospearl 120, manufactured by Momentive Performance Materials Japan LLC (formerly: Toshiba Silicone Co., Ltd.)) was dispersed in 8 parts of 2-methoxy-1-propanol was added to the dispersion liquid. Further, 0.008 part of a silicone oil (product name: SH28PA, manufactured by Dow Corning Toray Co., Ltd. (formerly: Toray Silicone Co., Ltd.)) was added to the mixture. The dispersion liquid thus prepared was applied onto the above-mentioned aluminum cylinder by a dipping method, and was heated and cured for 30 minutes in a hot-air dryer adjusted to 150 °C so that the coating film of the dispersion liquid was cured. Thus, an electroconductive layer having a thickness of 30 μm was formed.

### (Undercoat Layer)

The following materials were prepared.
Alcohol-soluble polyamide resin (Amilan CM-8000, manufactured by Toray Industries, Inc.): 10 parts
Methoxymethylated 6 nylon resin (Toresin EF-30T, manufactured by Teikoku Kagaku Sangyo K.K.): 30 parts

The materials were dissolved in a mixed solvent including 150 parts of methanol and 150 parts of butanol. The preparation liquid thus obtained was applied onto the electroconductive layer by a dip coating method, and dried at 90 °C for 10 minutes to form an undercoat layer having a thickness of 0.85 μm.

### (Charge Generating Layer)

The following materials were placed in a sand mill using glass beads each having a diameter of 1 mm, and dispersed for 4 hours. After that, 700 parts by mass of ethyl acetate was added to the resultant to prepare a coating liquid for a charge generating layer.
Hydroxygallium phthalocyanine crystal (charge generating substance) in a crystal form having diffraction peaks at least at positions where Bragg angles (2θ±0.2°) are 7.5°, 9.9°, 12.5°, 16.3°, 18.6°, 25.1°, and 28.3° in CuKα characteristic X-ray diffraction: 20 parts by mass
Polyvinylbutyral (product name: S-LEC (trademark) BBX-1, manufactured by SEKISUI CHEMICAL CO., LTD.): 10 parts by mass
Cyclohexanone: 600 parts by mass

The coating liquid for a charge generating layer was applied onto the undercoat layer by dip coating, and the resultant coating film was dried at 110 °C for 15 minutes to form a charge generating layer having a thickness of 0.20 μm.

### (Charge Transporting Layer)

The following materials were prepared.
Trihexylamine (manufactured by Tokyo Chemical Industry Co., Ltd.) (hereinafter referred to as “N1-1”) serving as an additive: 0.10 part
Compound represented by the formula (CTM-1) (charge transporting substance (CTM)) (CTM1 in Table 1 (Table 1-1 and Table 1-2)): 4,500 parts
Compound represented by the formula (CTM-2) (charge transporting substance (CTM)) (CTM2 in Table 1): 500 parts
Polyester resin 1 synthesized in Synthesis Example 1: 5,000 parts

The materials were dissolved in a mixed solvent including 25,000 parts of dimethoxymethane, 10,000 parts of o-xylene, and 15,000 parts of methyl benzoate to prepare a coating liquid for a charge transporting layer.

The coating liquid for a charge transporting layer was applied onto the charge generating layer by dip coating, and the resultant coating film was dried at 120 °C for 40 minutes to form a charge transporting layer having a thickness of 20 μm.

A photosensitive drum 1 was produced as described above.

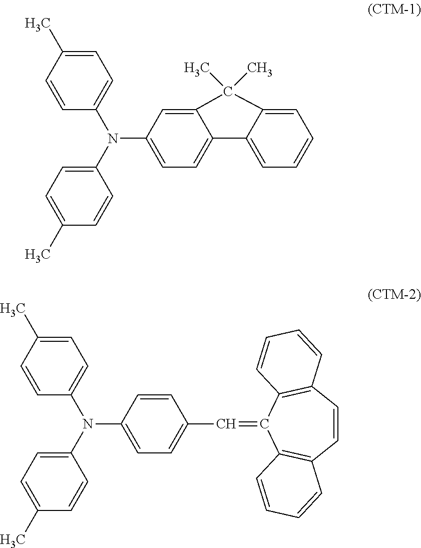 [SMILES: Cc1ccc(N(c2ccc(C)cc2)c2ccc3c(c2)C(C)(C)c2ccccc2-3)cc1 ; Cc1ccc(N(c2ccc(C)cc2)c2ccc(C=C3c4ccccc4C=Cc4ccccc43)cc2)cc1]

[Methods of producing Photosensitive Drums 2 to 39]

Photosensitive drums 2 to 39 were each produced in the same manner as in the photosensitive drum 1 except that, in the formation of the charge transporting layer in the method of producing the photosensitive drum 1, the mixture in the preparation of the coating liquid for a charge transporting layer was changed as shown in Table 1. The unit of an addition amount shown in Table 1 is “part(s).”

Additives used in the preparation of a coating liquid for a charge transporting layer in Table 1 are as described below.
Tripropylamine (hereinafter referred to as “N1-2”)
Trioctylamine (hereinafter referred to as “N1-3”)
Triethylamine (hereinafter referred to as “N1-4”)
Tridecylamine (hereinafter referred to as “N1-5”)
Tetrahexylammonium bromide (hereinafter referred to as “N2-1”)
Tetrahexylammonium chloride (hereinafter referred to as “N2-2”)
Benzyltributylammonium chloride (hereinafter referred to as “N2-3”)
Tetrapropylammonium bromide (hereinafter referred to as “N2-4”)
Tetraoctylammonium bromide (hereinafter referred to as “N2-5”)
Tetraethylammonium bromide (hereinafter referred to as “N2-6”)
Tetradecylammonium bromide (hereinafter referred to as “N2-7”)
Tributylphosphine (hereinafter referred to as “P-1”)
Tetrabutylphosphonium bromide (hereinafter referred to as “P-2”)

Products manufactured by Tokyo Chemical Industry Co., Ltd. were used as the additives N1-1, N1-2, N1-3, N1-4, N1-5, and P-1.

Products manufactured by Merck KGaA were used as the additives N2-1, N2-2, N2-4, N2-5, N2-6, N2-7, and P-2.

A product manufactured by Lion Specialty Chemicals Co., Ltd. was used as the additive N2-3.

A resin 5 used in the production of a coating liquid for a charge transporting layer shown in Table 1 is a bisphenol Z-type polycarbonate resin (product name: Iupilon Z400, manufactured by Mitsubishi Engineering-Plastics Corporation).

A charge transporting substance CTM3 used in the production of a coating liquid for a charge transporting layer in Table 1 is a compound represented by the following formula (CTM-3).

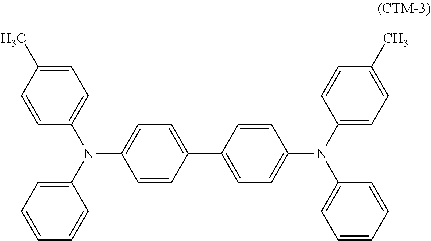 [SMILES: Cc1ccc(N(c2ccccc2)c2ccc(-c3ccc(N(c4ccccc4)c4ccc(C)cc4)cc3)cc2)cc1]

TABLE 1-1

| | Additive | | Resin | | | |
|---|---|---|---|---|---|---|
| | | Addition | | Addition | | Addition |
| | Kind | amount | Kind | amount | Kind | amount |
| Photosensitive drum 1 | N1-1 | 0.10 | Resin 1 | 5,000 | — | — |
| Photosensitive drum 2 | N1-1 | 0.10 | Resin 2 | 5,000 | — | — |
| Photosensitive drum 3 | N1-1 | 0.10 | Resin 1 | 2,500 | Resin 5 | 2,500 |
| Photosensitive drum 4 | N1-1 | 0.10 | Resin 3 | 5,000 | — | — |
| Photosensitive drum 5 | N1-1 | 0.10 | Resin 4 | 5,000 | — | — |
| Photosensitive drum 6 | N1-1 | 0.01 | Resin 1 | 5,000 | — | — |
| Photosensitive drum 7 | N1-1 | 0.20 | Resin 1 | 5,000 | — | — |
| Photosensitive drum 8 | N1-2 | 0.10 | Resin 1 | 5,000 | — | — |
| Photosensitive drum 9 | N1-3 | 0.10 | Resin 1 | 5,000 | — | — |
| Photosensitive drum 10 | N1-2 | 0.01 | Resin 1 | 5,000 | — | — |
| Photosensitive drum 11 | N1-2 | 0.20 | Resin 1 | 5,000 | — | — |
| Photosensitive drum 12 | N1-3 | 0.01 | Resin 1 | 5,000 | — | — |
| Photosensitive drum 13 | N1-3 | 0.20 | Resin 1 | 5,000 | — | — |
| Photosensitive drum 14 | N2-1 | 0.10 | Resin 1 | 5,000 | — | — |
| Photosensitive drum 15 | N2-2 | 0.10 | Resin 1 | 5,000 | — | — |
| Photosensitive drum 16 | N2-3 | 0.10 | Resin 1 | 5,000 | — | — |
| Photosensitive drum 17 | N2-1 | 0.10 | Resin 1 | 5,000 | — | — |
| Photosensitive drum 18 | N2-1 | 0.10 | Resin 1 | 2,500 | Resin 5 | 2,500 |
| Photosensitive drum 19 | N2-1 | 0.10 | Resin 3 | 5,000 | — | — |
| Photosensitive drum 20 | N2-1 | 0.10 | Resin 4 | 5,000 | — | — |
| Photosensitive drum 21 | N2-1 | 0.01 | Resin 1 | 5,000 | — | — |
| Photosensitive drum 22 | N2-1 | 0.20 | Resin 1 | 5,000 | — | — |
| Photosensitive drum 23 | N2-4 | 0.10 | Resin 1 | 5,000 | — | — |
| Photosensitive drum 24 | N2-5 | 0.10 | Resin 1 | 5,000 | — | — |
| Photosensitive drum 25 | N2-4 | 0.01 | Resin 1 | 5,000 | — | — |
| Photosensitive drum 26 | N2-4 | 0.20 | Resin 1 | 5,000 | — | — |
| Photosensitive drum 27 | N2-5 | 0.01 | Resin 1 | 5,000 | — | — |
| Photosensitive drum 28 | N2-5 | 0.20 | Resin 1 | 5,000 | — | — |
| Photosensitive drum 29 | P-1 | 0.10 | Resin 1 | 5,000 | — | — |
| Photosensitive drum 30 | P-2 | 0.10 | Resin 1 | 5,000 | — | — |
| Photosensitive drum 31 | — | — | Resin 1 | 5,000 | — | — |
| Photosensitive drum 32 | — | — | Resin 2 | 5,000 | — | — |
| Photosensitive drum 33 | — | — | Resin 1 | 2,500 | Resin 5 | 2,500 |
| Photosensitive drum 34 | N1-1 | 0.25 | Resin 1 | 5,000 | — | — |
| Photosensitive drum 35 | N1-4 | 0.10 | Resin 1 | 5,000 | — | — |
| Photosensitive drum 36 | N1-5 | 0.10 | Resin 1 | 5,000 | — | — |
| Photosensitive drum 37 | N2-1 | 0.25 | Resin 1 | 5,000 | — | — |
| Photosensitive drum 38 | N2-6 | 0.10 | Resin 1 | 5,000 | — | — |
| Photosensitive drum 39 | N2-7 | 0.10 | Resin 1 | 5,000 | — | — |

TABLE 1-2

| | CTM | | | |
|---|---|---|---|---|
| | | Addition | | Addition |
| | Kind | amount | Kind | amount |
| Photosensitive drum 1 | CTM1 | 4,500 | CTM2 | 500 |
| Photosensitive drum 2 | CTM1 | 2,500 | CTM3 | 2,500 |
| Photosensitive drum 3 | CTM1 | 4,500 | CTM2 | 500 |
| Photosensitive drum 4 | CTM1 | 4,500 | CTM2 | 500 |
| Photosensitive drum 5 | CTM1 | 4,500 | CTM2 | 500 |
| Photosensitive drum 6 | CTM1 | 4,500 | CTM2 | 500 |
| Photosensitive drum 7 | CTM1 | 4,500 | CTM2 | 500 |
| Photosensitive drum 8 | CTM1 | 4,500 | CTM2 | 500 |
| Photosensitive drum 9 | CTM1 | 4,500 | CTM2 | 500 |
| Photosensitive drum 10 | CTM1 | 4,500 | CTM2 | 500 |
| Photosensitive drum 11 | CTM1 | 4,500 | CTM2 | 500 |
| Photosensitive drum 12 | CTM1 | 4,500 | CTM2 | 500 |
| Photosensitive drum 13 | CTM1 | 4,500 | CTM2 | 500 |
| Photosensitive drum 14 | CTM1 | 4,500 | CTM2 | 500 |
| Photosensitive drum 15 | CTM1 | 4,500 | CTM2 | 500 |
| Photosensitive drum 16 | CTM1 | 4,500 | CTM2 | 500 |
| Photosensitive drum 17 | CTM1 | 2,500 | CTM3 | 2,500 |
| Photosensitive drum 18 | CTM1 | 4,500 | CTM2 | 500 |
| Photosensitive drum 19 | CTM1 | 4,500 | CTM2 | 500 |
| Photosensitive drum 20 | CTM1 | 4,500 | CTM2 | 500 |
| Photosensitive drum 21 | CTM1 | 4,500 | CTM2 | 500 |
| Photosensitive drum 22 | CTM1 | 4,500 | CTM2 | 500 |
| Photosensitive drum 23 | CTM1 | 4,500 | CTM2 | 500 |
| Photosensitive drum 24 | CTM1 | 4,500 | CTM2 | 500 |
| Photosensitive drum 25 | CTM1 | 4,500 | CTM2 | 500 |
| Photosensitive drum 26 | CTM1 | 4,500 | CTM2 | 500 |
| Photosensitive drum 27 | CTM1 | 4,500 | CTM2 | 500 |
| Photosensitive drum 28 | CTM1 | 4,500 | CTM2 | 500 |
| Photosensitive drum 29 | CTM1 | 4,500 | CTM2 | 500 |
| Photosensitive drum 30 | CTM1 | 4,500 | CTM2 | 500 |
| Photosensitive drum 31 | CTM1 | 4,500 | CTM2 | 500 |
| Photosensitive drum 32 | CTM1 | 2,500 | CTM3 | 2,500 |
| Photosensitive drum 33 | CTM1 | 4,500 | CTM2 | 500 |
| Photosensitive drum 34 | CTM1 | 4,500 | CTM2 | 500 |
| Photosensitive drum 35 | CTM1 | 4,500 | CTM2 | 500 |
| Photosensitive drum 36 | CTM1 | 4,500 | CTM2 | 500 |
| Photosensitive drum 37 | CTM1 | 4,500 | CTM2 | 500 |
| Photosensitive drum 38 | CTM1 | 4,500 | CTM2 | 500 |
| Photosensitive drum 39 | CTM1 | 4,500 | CTM2 | 500 |

### [Method of Producing Photosensitive Drum 40]

A chlorogallium phthalocyanine crystal was used instead of using the hydroxygallium phthalocyanine crystal in the preparation of the coating liquid for a charge generating layer in the production of the photosensitive drum 1. The chlorogallium phthalocyanine crystal has strong diffraction peaks at least at Bragg angles (2θ±0.20) of 7.4°, 16.6°, 25.5°, and 28.3° with respect to CuKα L characteristic X-rays. A photosensitive drum 40 was produced in the same manner as in the photosensitive drum 1 except for the foregoing.

### [Method of Producing Photosensitive Drum 41]

An oxytitanium phthalocyanine crystal was used instead of using the hydroxygallium phthalocyanine crystal in the preparation of the coating liquid for a charge generating layer in the production of the photosensitive drum 1. The oxytitanium phthalocyanine crystal has a diffraction peak at least at a position where a Bragg angle (2θ±0.2°) is 27.3° in an X-ray diffraction spectrum using a CuKα characteristic X-ray. A photosensitive drum 41 was produced in the same manner as in the photosensitive drum 1 except for the foregoing.

### [Method of Producing Photosensitive Drum 42]

A chlorogallium phthalocyanine crystal was used instead of using the hydroxygallium phthalocyanine crystal in the preparation of the coating liquid for a charge generating layer in the production of the photosensitive drum 14. The chlorogallium phthalocyanine crystal has strong diffraction peaks at least at Bragg angles (2θ±0.2°) of 7.4°, 16.6°, 25.5°, and 28.3° with respect to CuKα characteristic X-rays. A photosensitive drum 42 was produced in the same manner as in the photosensitive drum 14 except for the foregoing.

### [Method of Producing Photosensitive Drum 43]

An oxytitanium phthalocyanine crystal was used instead of using the hydroxygallium phthalocyanine crystal in the preparation of the coating liquid for a charge generating layer in the production of the photosensitive drum 14. The oxytitanium phthalocyanine crystal has a diffraction peak at least at a position where a Bragg angle (2θ+0.2°) is 27.3° in an X-ray diffraction spectrum using a CuKα characteristic X-ray. A photosensitive drum 43 was produced in the same manner as in the photosensitive drum 14 except for the foregoing.

### [Method of Producing Photosensitive Drum 44]

An oxytitanium phthalocyanine crystal was used instead of using the hydroxygallium phthalocyanine crystal in the preparation of the coating liquid for a charge generating layer in the production of the photosensitive drum 29. The oxytitanium phthalocyanine crystal has a diffraction peak at least at a position where a Bragg angle (2θ+0.2°) is 27.3° in an X-ray diffraction spectrum using a CuKα characteristic X-ray. A photosensitive drum 44 was produced in the same manner as in the photosensitive drum 29 except for the foregoing.

### [Method of Producing Photosensitive Drum 45]

An oxytitanium phthalocyanine crystal was used instead of using the hydroxygallium phthalocyanine crystal in the preparation of the coating liquid for a charge generating layer in the production of the photosensitive drum 30. The oxytitanium phthalocyanine crystal has a diffraction peak at least at a position where a Bragg angle (2θ±0.2°) is 27.3° in an X-ray diffraction spectrum using a CuKα characteristic X-ray. A photosensitive drum 45 was produced in the same manner as in the photosensitive drum 30 except for the foregoing.

### Example 1

### <Evaluation>

A reconstructed machine in which an organic EL element using a perylene derivative as a light emitting material was arranged on a portion of a multifunctional device (product name: imageRUNNER ADVANCE C5930F) manufactured by CANON KABUSHIKI KAISHA from which an exposure portion had been removed was used as an evaluation device. The organic EL element arranged on the above-mentioned reconstructed machine is a light emitting element for the light emitting substrate of a solid-state exposure head. The above-mentioned reconstructed machine was configured to perform a pre-exposing step.

The above-mentioned evaluation device was placed in an environment at 30 °C and 80%.

After that, the photosensitive drum 1 produced in the foregoing was mounted on the above-mentioned evaluation device, and evaluation was performed.

### (Evaluation of Exposure Memory)

The evaluation of exposure memory was performed by using the above-mentioned evaluation device.

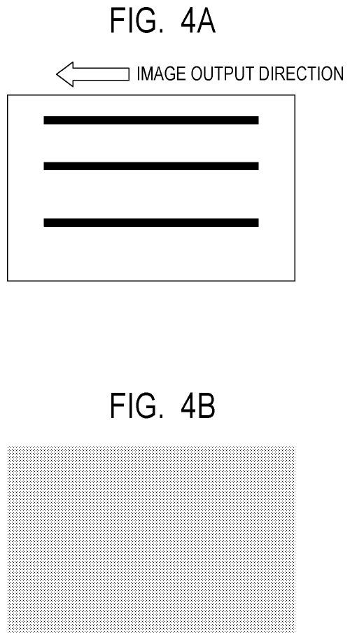

A cartridge mounted with the photosensitive drum was attached to the evaluation device, and an A3-size test chart having a solid black area and a solid white area illustrated in FIG. 4A was used. The test chart was continuously output on 5,000 sheets, and then a halftone image with an area ratio of 25% illustrated in FIG. 4B was output.

The densities of the halftone image at portions corresponding to the solid black area and the solid white area illustrated in FIG. 4A were measured on FIG. 4B with a reflection densitometer (manufactured by X-Rite, Inc.: 504 spectrodensitometer). Specifically, a difference between the average density of ten points corresponding to the solid black area and the average density of ten points corresponding to the solid white area was determined.

In the evaluation, a relative value when the density difference in Comparative Example 1 was set to 1 was defined as an evaluation value. A smaller evaluation value means that exposure memory is more satisfactorily suppressed.

A case in which the relative value was less than 0.80 was defined as Rank A.

A case in which the relative value was 0.80 or more and less than 0.85 was defined as Rank B.

A case in which the relative value was 0.85 or more and less than 1.00 was defined as Rank C.

A case in which the relative value was 1.00 or more was defined as Rank D.

The results are shown in Table 2.

### Examples 2 to 36 and Comparative Examples 1 to 9

The same evaluation as that in Example 1 was performed except that in Example 1, the photosensitive drum used in the evaluation was changed as shown in Table 2. The results are shown in Table 2.

### [Measurement of Contents of Compound Represented by Formula (1) and Compound Represented by Formula (2) in Charge Transporting Layer]

The contents of the compound represented by the formula (1) and the compound represented by the formula (2) in each of the charge transporting layers were measured by the following method.

The charge transporting layer of each of the photosensitive drums 1 to 45 was removed from the top of the corresponding charge generating layer. Thus, a solid of the charge transporting layer was obtained. The solid of the charge transporting layer was dissolved in chloroform and reprecipitated in methanol. The reprecipitation solution was separated through filtration with a filter having a pore diameter of 0.45 μm from an insoluble substance to provide a sample solution. The sample solution was analyzed with a liquid chromatograph-mass spectrometer (manufactured by Agilent Technologies, Inc.: 6130-Quadrupole LC/MS system). Analysis conditions are as described below.
Column: SB-C18 (2.1 mm×5 mm, 1.8 μm) manufactured by Agilent Technologies, Inc.
Column temperature: 40 °C
Solvent: methanol

The contents of the compound represented by the formula (1) and the compound represented by the formula (2) in the charge transporting layer were calculated from the peak areas of the respective compounds obtained by the measurement. In the calculation of the contents, a calibration curve exhibiting a relationship between a peak area and a content, the curve being determined in advance by using a standard sample, was used.

The obtained result (the total ratio of the content of the compound represented by the formula (1) and the content of the compound represented by the formula (2) in the charge transporting layer to the total mass (solid content) of the charge transporting layer) is shown in the column “Total of contents of formula (1) and formula (2) (ppm)” in Table 2.

In addition, photosensitive drums 1a to 45a were produced in the same manner during the production of the photosensitive drums 1 to 45, and the contents of the compound represented by the formula (1) and the compound represented by the formula (2) in each of their charge transporting layers were measured by the above-mentioned method without performance of the evaluation of exposure memory. The results were the same as the measured values obtained for the photosensitive drums 1 to 45 used in the evaluation of exposure memory.

TABLE 2

| | | Total of contents of | Exposure memory | |
|---|---|---|---|---|
| | Photosensitive | formula (1) and formula | Evaluation | |
| | drum | (2) (ppm) | value | Judgment |
| Example 1 | 1 | 10 | 0.74 | A |
| Example 2 | 2 | 10 | 0.75 | A |
| Example 3 | 3 | 10 | 0.76 | A |
| Example 4 | 4 | 10 | 0.74 | A |
| Example 5 | 5 | 10 | 0.74 | A |
| Example 6 | 6 | 1 | 0.82 | B |
| Example 7 | 7 | 20 | 0.80 | B |
| Example 8 | 8 | 10 | 0.82 | B |
| Example 9 | 9 | 10 | 0.81 | B |
| Example 10 | 10 | 1 | 0.84 | B |
| Example 11 | 11 | 20 | 0.84 | B |
| Example 12 | 12 | 1 | 0.84 | B |
| Example 13 | 13 | 20 | 0.84 | B |
| Example 14 | 40 | 10 | 0.74 | A |
| Example 15 | 41 | 10 | 0.80 | B |
| Example 16 | 14 | 10 | 0.83 | B |
| Example 17 | 15 | 10 | 0.82 | B |
| Example 18 | 16 | 10 | 0.82 | B |
| Example 19 | 17 | 10 | 0.82 | B |
| Example 20 | 18 | 10 | 0.83 | B |
| Example 21 | 19 | 10 | 0.83 | B |
| Example 22 | 20 | 10 | 0.83 | B |
| Example 23 | 21 | 1 | 0.85 | C |
| Example 24 | 22 | 20 | 0.85 | C |
| Example 25 | 23 | 10 | 0.86 | C |
| Example 26 | 24 | 10 | 0.85 | C |
| Example 27 | 25 | 1 | 0.87 | C |
| Example 28 | 26 | 20 | 0.86 | C |
| Example 29 | 27 | 1 | 0.87 | C |
| Example 30 | 28 | 20 | 0.87 | C |
| Example 31 | 42 | 10 | 0.83 | B |
| Example 32 | 43 | 10 | 0.86 | C |
| Example 33 | 29 | 10 | 0.83 | B |
| Example 34 | 30 | 10 | 0.84 | B |
| Example 35 | 44 | 10 | 0.86 | C |
| Example 36 | 45 | 10 | 0.87 | C |
| Comparative Example 1 | 31 | 0 | 1.00 | D |
| Comparative Example 2 | 32 | 0 | 1.01 | D |
| Comparative Example 3 | 33 | 0 | 1.00 | D |
| Comparative Example 4 | 34 | 25 | 1.01 | D |
| Comparative Example 5 | 35 | 0 | 1.01 | D |
| Comparative Example 6 | 36 | 0 | 1.00 | D |
| Comparative Example 7 | 37 | 25 | 1.00 | D |
| Comparative Example 8 | 38 | 0 | 1.01 | D |
| Comparative Example 9 | 39 | 0 | 1.00 | D |

According to the present disclosure, there can be provided an image forming apparatus that suppresses an image defect caused by exposure memory during repeated use and can stably form an image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067022, filed Apr. 15, 2025, which is hereby incorporated by reference herein in its entirety.

What is claimed is:

1. An image forming apparatus comprising:
a photosensitive drum; and
light emitting elements for emitting exposure light to be applied to a surface of the photosensitive drum,
wherein the light emitting elements are each an organic EL element,
wherein the photosensitive drum includes a support, a charge generating layer, and a charge transporting layer,
wherein the charge transporting layer contains at least one compound selected from the group consisting of: a compound represented by the following formula (1); and a compound represented by the following formula (2), and
wherein a total of a content of the compound represented by the formula (1) and a content of the compound represented by the formula (2) in the charge transporting layer is 1 to 20 ppm with respect to a total mass of the charge transporting layer: 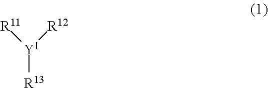
in the formula (1), R¹¹, R¹², and R¹³ each independently represent an alkyl group having 3 to 8 carbon atoms, and Y¹ represents a nitrogen atom or a phosphorus atom; 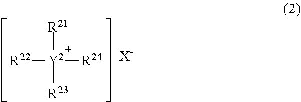
in the formula (2), R²¹, R²², and R²³ each independently represent an alkyl group having 3 to 8 carbon atoms, R²⁴ represents an alkyl group or an alkyl group having an aromatic group as a substituent, X represents a halogen atom, and Y² represents a nitrogen atom or a phosphorus atom.

2. The image forming apparatus according to claim 1, wherein Y¹ in the formula (1) represents a nitrogen atom, and Y² in the formula (2) represents a nitrogen atom.

3. The image forming apparatus according to claim 2, wherein the charge transporting layer contains the compound represented by the formula (1).

4. The image forming apparatus according to claim 1, wherein the charge transporting layer contains a polyester resin serving as a binder resin.

5. The image forming apparatus according to claim 4, wherein the polyester resin has a structure represented by the following formula (a) and a structure represented by the following formula (b): 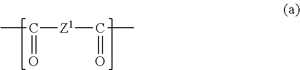
in the formula (a), Z¹ represents a m-phenylene group unsubstituted or substituted by one or more methyl groups, a p-phenylene group unsubstituted or substituted by one or more methyl groups, a divalent group in which two m-phenylene groups or p-phenylene groups are bonded to each other via an oxygen atom, or a naphthylene group; 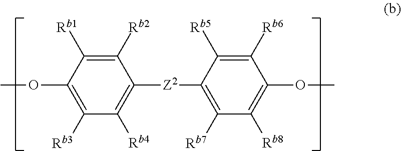
in the formula (b), Z² represents a single bond, an oxygen atom, an alkylidene group, or a cycloalkylidene group, and R^{b1} to R^{b8} each independently represent a hydrogen atom or an alkyl group.

6. The image forming apparatus according to claim 1, wherein the charge generating layer contains one of a hydroxygallium phthalocyanine compound or a chlorogallium phthalocyanine compound.

7. The image forming apparatus according to claim 1, wherein, when a wavelength of a peak having a highest emission intensity in an emission spectrum of each of the organic EL elements is represented by λ₀ (nm), the λ₀ is 500 to 700 nm.

8. The image forming apparatus according to claim 1, wherein, when a wavelength of a peak having a highest emission intensity in an emission spectrum of each of the organic EL elements is represented by λ₀ (nm), and out of wavelengths each having an emission intensity that is 10% of the emission intensity at the λ₀, a wavelength closest to the λ₀ in a wavelength region shorter than the λ₀ is represented by λ₁ (nm), and a wavelength closest to the λ₀ in a wavelength region longer than the λ₀ is represented by λ₂ (nm), 80≤λ₂−λ₁≤150 is satisfied.
